(19) United States
(12) Patent Application Publication
(10) Pub. No.: US 2026/0317115 A1
(43) Pub. Date: Oct. 15, 2026

(54) SHEET PROCESSING APPARATUS, SHEET PROCESSING METHOD, AND IMAGE FORMING SYSTEM

(71) Applicants: Masahiro TAMURA, Kanagawa (JP); Keisuke SUGIYAMA, Kanagawa (JP); Yuusuke SHIBASAKI, Kanagawa (JP); Michitaka SUZUKI, Kanagawa (JP); Shinji ASAMI, Kanagawa (JP); Tomonichi HOSHINO, Kanagawa (JP); Kei SASAKI, Kanagawa (JP); Masanobu KIMATA, Kanagawa (JP); Wataru TAKAHASHI, Kanagawa (JP)

(72) Inventors: Masahiro TAMURA, Kanagawa (JP); Keisuke SUGIYAMA, Kanagawa (JP); Yuusuke SHIBASAKI, Kanagawa (JP); Michitaka SUZUKI, Kanagawa (JP); Shinji ASAMI, Kanagawa (JP); Tomonichi HOSHINO, Kanagawa (JP); Kei SASAKI, Kanagawa (JP); Masanobu KIMATA, Kanagawa (JP); Wataru TAKAHASHI, Kanagawa (JP)

(73) Assignee: Ricoh Company, Ltd., Ohta-ku, Tokyo (JP)

(21) Appl. No.: 19/485,092

(22) PCT Filed: Jul. 17, 2024
(86) PCT No.: PCT/IB2024/056907

§ 371 Date: Nov. 17, 2025

(30) Foreign Application Priority Data
Jul. 18, 2023 (JP) 2023-117060
Apr. 8, 2024 (JP) 2024-062264

(51) Int. Cl. B65H 45/30; B42C 3/00; G03G 15/00

(52) U.S. Cl. CPC B65H 45/30; B42C 3/00; G03G 15/6544; G03G 15/6585; B65H 2301/5121; B65H 2301/51616; B65H 2301/5162; B65H 2801/06; G03G 2215/00835; G03G 2215/00877

(57) ABSTRACT

A sheet processing apparatus includes a center folder, and a back-crimp binder. The center folder performs a center folding on a sheet bundle including multiple sheets. The back-crimp binder includes a back-portion former and a crimp binder. The back-portion former forms a back portion on the sheet bundle subjected to the center folding. The crimp binder performs a crimp binding on the sheet bundle subjected to the center folding.

### TECHNICAL FIELD

The present disclosure relates to a sheet processing apparatus, a sheet processing method, and an image forming system.

### BACKGROUND ART

There is known a sheet processing apparatus that can execute a “binding process” of binding a sheet bundle in which sheet-like recording media have been put together. Multiple types of binding process are known as binding processes to be executed in the sheet processing apparatus. For example, “edge stitching” (or “edge binding”) and “saddle stitching” (or “center binding”) are known. The “edge stitching” (or “edge binding”) is for binding an edge of a sheet bundle. The “saddle stitching” (or “center binding”) is for folding a sheet bundle in two and binding the sheet bundle at a portion in the vicinity of a folding position. The center binding is a binding method mainly used when a book such as a booklet is made.

For the purpose of providing a center-bound booklet having aligned edges without cutting the edges, there has been disclosed a center-bound bookbinding apparatus that performs square-back folding for forming a square back on a booklet after crimp binding is performed at binding positions on both sides away from a center-folding position (see, for example, Patent Literature (PTL) 1).

In addition, for the purpose of providing a crimp-center-binding apparatus, there has been disclosed a center-bound bookbinding apparatus that performs crimp binding at a position away from a folding position (see, for example, PTL 2).

Moreover, there has been disclosed a staple-saddle-stitching bookbinding apparatus that is a staple-saddle-stitching apparatus that performs square-back folding on the back portion of a booklet, and includes a stopper plate in which a groove has been formed such that a staple is to be fitted in the groove, for the purpose of providing a booklet in which a staple is less likely to be displaced from the center of the back portion for improvement in appearance (see, for example, PTL 3).

Furthermore, for the purpose of providing a booklet bound with no staple, there has been disclosed a crimp-center-binding bookbinding apparatus that performs a center folding after performing the crimp binding of a booklet at a central portion thereof (see, for example, PTL 4).

In addition, there has been disclosed a bookbinding apparatus that forms toner layers for adhesion at, for example, edges of sheets, and heats and pressurizes the toner layers to bond the sheets to each other in an electrophotographic image forming apparatus (see, for example, PTL 5).

### CITATION LIST

### Patent Literature

[PTL 1]
Japanese Unexamined Patent Application Publication No. 2014-031268
[PTL 2]
Japanese U.S. Pat. No. 6,089,675
[PTL 3]
Japanese Unexamined Patent Application Publication No. 2004-168012
[PTL 4]
Japanese U.S. Pat. No. 5,361,858
[PTL 5]
Japanese Unexamined Patent Application Publication No. 2004-209858

### SUMMARY OF INVENTION

### Technical Problem

The above patent documents disclose conventional techniques of performing a crimp center binding and performing a square-back folding process on the back portion of a booklet. However, making a center-bound booklet by using these conventional techniques is disadvantageous in that a double-page spread becomes incongruous when a page is turned, or a load is applied to a crimped portion by a page turning action to cause the crimped portion to be peeled off. That is, the conventional techniques have disadvantages in quality and binding strength of a completed product when crimp binding is used for saddle stitching (center binding).

An object of the present disclosure is to provide a sheet processing apparatus that can form a crimp-bound booklet that can be easily opened without causing a crimp-bound portion to be peeled off by a page turning action.

### Solution to Problem

According to an embodiment of the present disclosure, a sheet processing apparatus includes a center folder, and a back-crimp binder. The center folder performs a center folding on a sheet bundle including multiple sheets. The back-crimp binder includes a back-portion former and a crimp binder. The back-portion former forms a back portion on the sheet bundle subjected to the center folding. The crimp binder performs a crimp binding on the sheet bundle subjected to the center folding.

### Advantageous Effects of Invention

According to the present disclosure, it is possible to form a crimp-center-bound booklet that can be easily opened without causing a crimp-bound portion to be peeled off by a page turning action.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an overall configuration of an image forming system according to a first embodiment.

FIG. 2 is a diagram illustrating an internal structure of a post-processing apparatus according to the first embodiment.

FIG. 3 is a schematic diagram illustrating an edge binder viewed from an ejection port side.

FIGS. 4A and 4B are schematic diagrams illustrating configurations of crimping teeth of a crimp-edge-binding processing unit.

FIGS. 5A, 5B, 5C, 5D and 5E are diagrams illustrating movement positions of the edge binder.

FIGS. 6A, 6B, 6C, 6D and 6E are schematic diagrams illustrating operation of a crimp center binder.

FIGS. 7A, 7B and 7C are cross-sectional views of the crimp center binder, which illustrate operation of the crimp center binder.

FIG. 8 is a schematic diagram illustrating a state of pressing performed by the crimp center binder.

FIG. 9 is a schematic view of a crimp-center-bound booklet bound in the first embodiment.

FIG. 10 is a hardware configuration diagram of a control device of the post-processing apparatus.

FIG. 11 is a schematic diagram illustrating a first modification of the crimp center binder.

FIGS. 12A and 12B are cross-sectional views taken along line B-B, which illustrate operation of the crimp center binder according to the first modification.

FIGS. 13A and 13B are cross-sectional views of a crimp center binder according to a second modification, which illustrate operation of the crimp center binder.

FIGS. 14A and 14B are cross-sectional views of a crimp center binder according to a third modification, which illustrate operation of the crimp center binder.

FIGS. 15A, 15B, and 15C are cross-sectional views of a crimp center binder according to a fourth modification, which illustrate operation of the crimp center binder.

FIGS. 16A, 16B and 16C are cross-sectional views of a crimp center binder according to a fifth modification, which illustrate operation of the crimp center binder.

FIG. 17 is a schematic view of a crimp-center-bound booklet bound in the fifth modification.

FIG. 18 is a schematic diagram illustrating a sixth modification of the crimp center binder.

FIG. 19 is a schematic view of a crimp-center-bound booklet bound in the sixth modification.

FIGS. 20A, 20B, 20C and 20D are cross-sectional views of a crimp center binder according to a seventh modification, which illustrate operation of the crimp center binder.

FIG. 21 is a schematic diagram illustrating an eighth modification of the crimp center binder.

FIGS. 22A, 22B and 22C are cross-sectional views of a crimp center binder according to the eighth modification, which illustrate operation of the crimp center binder.

FIGS. 23A and 23B are schematic views of a crimp-center-bound booklet bound in the eighth modification.

FIGS. 24A and 24B are cross-sectional views of a crimp center binder according to a ninth modification, which illustrate operation of the crimp center binder.

FIG. 25 is a diagram illustrating an overall configuration of an image forming system according to a second embodiment.

FIG. 26 is a diagram illustrating an internal structure of a post-processing apparatus according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

### First Embodiment

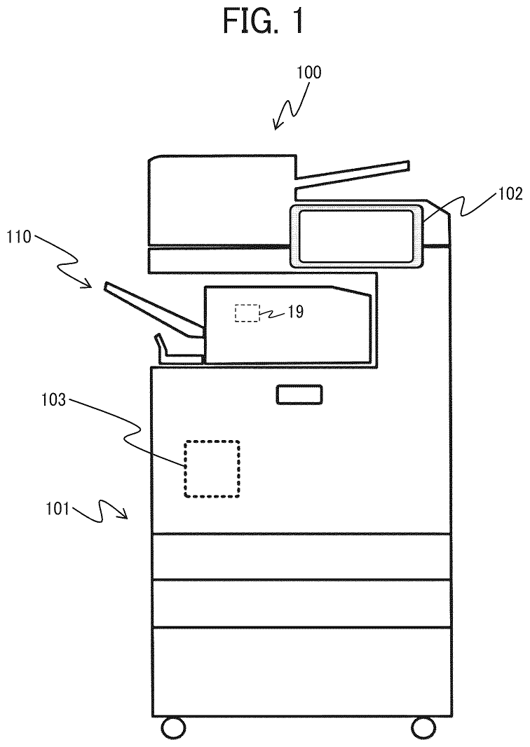

Hereinafter, a first embodiment of a sheet processing apparatus, a sheet processing method, and an image forming system according to the present disclosure will be described with reference to the drawings. FIG. 1 is a diagram illustrating an overall configuration of an image forming system 100 such as a multifunction printer (MFP). As illustrated in FIG. 1, the image forming system 100 includes an image forming apparatus 101 and a post-processing apparatus 110. The image forming apparatus 101 forms an image on a sheet P corresponding to an example of a sheet material as a sheet-like medium. The post-processing apparatus 110 executes predetermined post-processing on the sheet P on which an image has been formed. The image forming system 100 corresponds to an embodiment of an in-body ejection image forming system in which the post-processing apparatus 110 is disposed in an in-body ejection space (in-body ejection unit) of the image forming apparatus 101.

The image forming apparatus 101 forms an image on the sheet P, and ejects the sheet P on which the image has been formed to the post-processing apparatus 110. The image forming apparatus 101 includes a tray, a conveyor, and an image former. Sheets P are stored in the tray. The conveyor conveys a sheet P stored in the tray. The image former forms an image on the sheet P conveyed by the conveyor. The image former can execute a known image forming method. For example, the image former may use an inkjet method for discharging liquid ink toward the sheet P and causing the liquid ink to adhere to the sheet P to form an image, or may use an electrophotographic method for forming an image by using toner.

The image forming apparatus 101 includes an operation panel 102, and a controller 103 that controls the operations of the image forming apparatus 101. The configuration and operation of the image forming apparatus 101 correspond to the configuration and operation known in the art, and thus detailed description thereof will be omitted.

Next, a detailed description will be given of the post-processing apparatus 110 as an embodiment of the sheet processing apparatus according to the present disclosure.

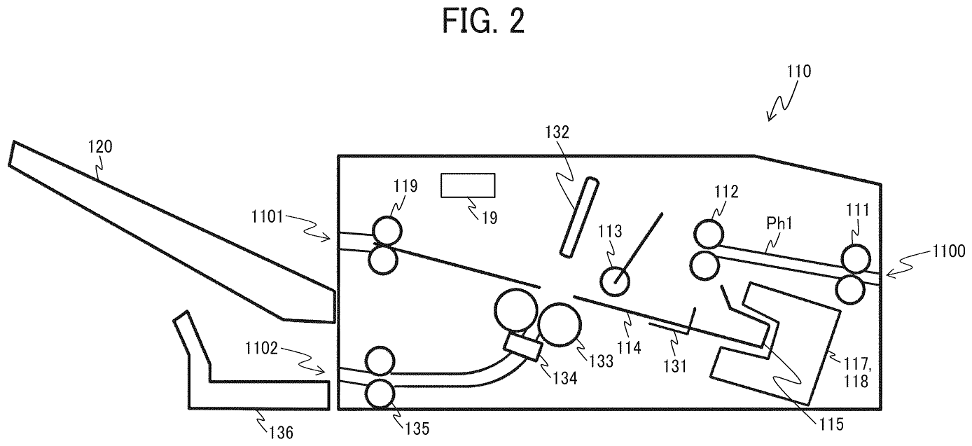

FIG. 2 is a diagram illustrating an internal structure of the post-processing apparatus 110 according to the first embodiment.

The post-processing apparatus 110 has a function of performing post-processing on the sheet P on which an image has been formed by the image forming apparatus 101. The post-processing apparatus 110 performs a binding process of receiving the sheet P on which an image has been formed through a carry-in port 1100, through which the sheet P is received from the image forming apparatus 101, and binding a sheet bundle Pb in which a plurality of sheets has been put together.

More specifically, the binding according to the present embodiment includes “crimp binding” and “stapling.” The crimp binding is a process of pressing and deforming the sheet bundle Pb, which includes a plurality of stacked sheets P, at a binding position to bind the sheet bundle Pb. The stapling is a process of binding the sheet bundle Pb with a staple at the binding position. The crimp binding includes edge binding and center binding. The edge binding is a process to bind an edge of the sheet bundle Pb. The center binding is a process to bind the center portion of the sheet bundle Pb.

The post-processing apparatus 110 includes a first conveyance roller pair 111 and a second conveyance roller pair 112 for conveying the sheet P carried in through the carry-in port 1100 along a conveyance path. The first conveyance roller pair 111 and the second conveyance roller pair 112 convey the sheet P fed from the image forming apparatus 101 along a first conveyance path Ph1 inside the post-processing apparatus 110.

The first conveyance path Ph1 is a path extending from the carry-in port 1100, through which the sheet P is carried in from the image forming apparatus 101, to an inner tray 114.

### Edge Binding

The post-processing apparatus 110 includes a return conveyance roller 113, the inner tray 114, an end fence 115, side fences 116, a staple-edge-binding processing unit 117, a crimp-edge-binding processing unit 118, an ejection roller pair 119, and an ejection tray 120. The staple-edge-binding processing unit 117 and the crimp-edge-binding processing unit 118 serve as edge-stitching units.

The return conveyance roller 113 serves as a conveyance roller for placing, on the inner tray 114, the sheet P having passed through the second conveyance roller pair 112, and conveying the sheet P on the inner tray 114 toward the end fence 115. A direction of conveyance by the return conveyance roller 113 is different from a direction of conveyance by the first conveyance roller pair 111 and the second conveyance roller pair 112, and corresponds to a direction (reverse direction) in which the sheet P conveyed by the first conveyance roller pair 111 and the second conveyance roller pair 112 is turned around. Therefore, the conveyance by the return conveyance roller 113 is referred to as switchback conveyance.

The sheet P as a sheet material is conveyed to the inner tray 114 by the first conveyance roller pair 111, the second conveyance roller pair 112, and the return conveyance roller 113, and is subjected to a binding process. The first conveyance roller pair 111, the second conveyance roller pair 112, the return conveyance roller 113, and the first conveyance path Ph1 form a conveyor that conveys the sheet P to the inner tray 114 serving as a stacker.

The inner tray 114 corresponds to a stacker on which a plurality of sheets P sequentially conveyed is temporarily placed. The sheets P placed on the inner tray 114 are switchback-conveyed by the return conveyance roller 113 to a position where the sheets P collide with the end fence 115. The end fence 115 serves as an alignment member for aligning edges of the sheets P in the direction of the switchback conveyance. Edges of the plurality of sheets P stacked on the inner tray 114 are aligned by the end fence 115 to form the sheet bundle Pb.

A pair of the side fences 116 is disposed in a width direction of the inner tray 114 (width direction of the sheets P). In other words, the pair of side fences 116 is disposed at both side ends of the inner tray 114 in a direction orthogonal to the direction in which the sheets P are switchback-conveyed, that is, the direction in which the sheets P are conveyed to the end fence 115.

The side fences 116 perform “jogging operation” in which the side fences 116 repeat coming into contact with and separating from the width-directional edges of the plurality of sheets P stacked on the inner tray 114. By this jogging operation, the width-directional edges of the plurality of sheets P are also aligned. That is, the side fences 116 serve as an alignment member for aligning both width-directional edges (both edges in the direction orthogonal to the conveyance direction) of the sheets P placed on the inner tray 114.

The staple-edge-binding processing unit 117 and the crimp-edge-binding processing unit 118 serving as edge-stitching units perform a binding process on an edge of the sheet bundle Pb aligned by the end fence 115 and the side fences 116.

After the binding process is performed, the return conveyance roller 113 rotates in contact with the sheet bundle Pb placed on the inner tray 114. A direction of the rotation performed at this time is opposite to a direction of rotation performed during switchback conveyance.

Therefore, the sheet bundle Pb subjected to edge stitching (edge binding) is ejected from a first ejection port 1101 toward the ejection tray 120 by the return conveyance roller 113.

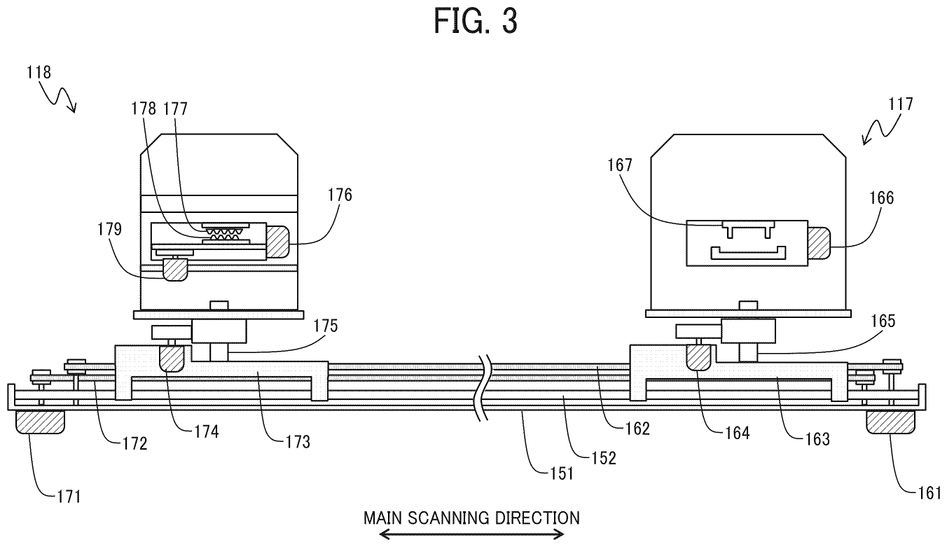

The “edge stitching” (or “edge binding”) to be performed on the sheet bundle Pb by the staple-edge-binding processing unit 117 and the crimp-edge-binding processing unit 118 includes multiple types of processes. For example, the “edge stitching” includes a “parallel-binding process,” an “oblique-binding process,” and a “two-location-binding process.” In the “parallel-binding process,” binding is performed along one side parallel to a main scanning direction of the sheet bundle Pb (see FIG. 3). In the “oblique-binding process,” binding is performed at a corner of the sheet bundle Pb. In the “two-location-binding process,” binding is performed at a plurality of locations separated in the width direction along one side parallel to the conveyance direction of the sheet bundle Pb.

FIG. 3 is a schematic diagram illustrating an edge-stitching unit 1110 including the staple-edge-binding processing unit 117 and the crimp-edge-binding processing unit 118, as viewed in a direction from the first ejection port 1101 toward the end fence 115.

As illustrated in FIG. 3, the edge-stitching unit 1110 is attached to an edge-stitching unit base member 151 in a state where the staple-edge-binding processing unit 117 and the crimp-edge-binding processing unit 118 are separated from each other in the main scanning direction.

The edge-stitching unit 1110 is supported by a guide shaft 152 extending in the main scanning direction, via the edge-stitching unit base member 151. Therefore, both the staple-edge-binding processing unit 117 and the crimp-edge-binding processing unit 118 are supported in such a way as to be movable along the guide shaft 152.

The staple-edge-binding processing unit 117 includes a staple-edge-binding main scanning motor 161, a driving force transmission mechanism 162, and a staple-edge-binding processing unit base member 163. The staple-edge-binding processing unit 117 is movable in the main scanning direction along the guide shaft 152 by the driving force of the staple-edge-binding main scanning motor 161.

The staple-edge-binding main scanning motor 161 generates a driving force for moving the staple-edge-binding processing unit 117. The driving force transmission mechanism 162 transmits the driving force of the staple-edge-binding main scanning motor 161 to the staple-edge-binding processing unit base member 163 via a pulley and a timing belt. Accordingly, the staple-edge-binding processing unit 117 is movable in the main scanning direction along the guide shaft 152.

The staple-edge-binding processing unit 117 further includes a staple-edge-binding posture rotation motor 164, and rotates around a stapling rotation shaft 165 as a rotation center with respect to the staple-edge-binding processing unit base member 163.

In addition, the staple-edge-binding processing unit 117 includes a staple-edge-binding clinch motor 166, and causes a staple clincher 167 to perform an opening-closing operation. Thus, a staple penetrates the sheet bundle Pb, then is clinched to execute stapling.

The crimp-edge-binding processing unit 118 includes a crimp-edge-binding main scanning motor 171, a driving force transmission mechanism 172, and a crimp-edge-binding processing unit base member 173. The crimp-edge-binding processing unit 118 is movable in the main scanning direction along the guide shaft 152 by the driving force of the crimp-edge-binding main scanning motor 171.

The crimp-edge-binding main scanning motor 171 generates a driving force for moving the crimp-edge-binding processing unit 118. The driving force transmission mechanism 172 transmits the driving force of the crimp-edge-binding main scanning motor 171 to the crimp-edge-binding processing unit base member 173 via a pulley and a timing belt. As a result, the crimp-edge-binding processing unit 118 becomes movable in the main scanning direction along the guide shaft 152.

Furthermore, the crimp-edge-binding processing unit 118 includes a crimp-edge-binding posture rotation motor 174, and rotates around a crimp-binding rotation shaft 175 as a rotation center with respect to the crimp-edge-binding processing unit base member 173.

In addition, the crimp-edge-binding processing unit 118 includes a crimp-edge-binding clinch motor 176, and causes an “opening-closing operation” to be performed by the driving force of the crimp-edge-binding clinch motor 176. In the opening-closing operation, upper crimping teeth 177 approach or separate from lower crimping teeth 178. With this opening-closing operation, it is possible to nip the edge of the sheet bundle Pb between the upper crimping teeth 177 and the lower crimping teeth 178 having a protruding-recessed shape and to press and deform the sheet bundle Pb. Due to this pressure deformation, fibers of the sheets P included in the sheet bundle Pb are entangled with each other to form the sheet bundle Pb of the plurality of sheets P. As described above, binding based on pressure deformation is referred to as “crimp binding.”

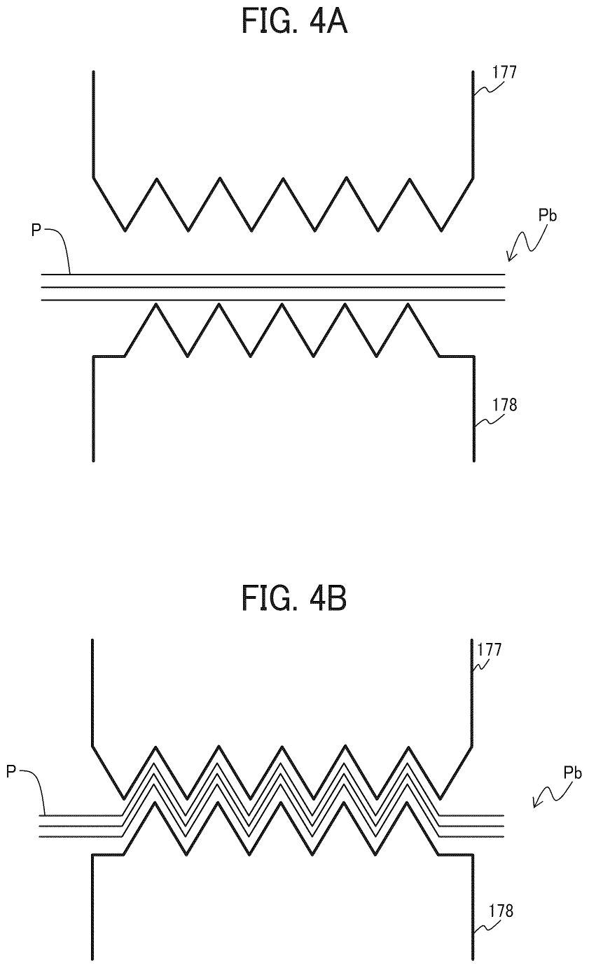

FIGS. 4A and 4B are schematic diagrams illustrating configurations of the upper crimping teeth 177 and the lower crimping teeth 178 each serving as a crimping portion included in the crimp-edge-binding processing unit 118.

As illustrated in FIGS. 4A and 4B, the crimping portion includes a pair of upper crimping teeth 177 and lower crimping teeth 178. The upper crimping teeth 177 and the lower crimping teeth 178 are arranged in such a way as to face each other in a thickness direction of the sheet bundle Pb such that the sheet bundle Pb placed on the inner tray 114 can be sandwiched between the upper crimping teeth 177 and the lower crimping teeth 178. The upper crimping teeth 177 and the lower crimping teeth 178 are formed in a protruding-recessed shape in which recesses and protrusions are alternately formed. In addition, the upper crimping teeth 177 and the lower crimping teeth 178 are formed such that the recesses and protrusions are displaced so that the upper crimping teeth 177 and the lower crimping teeth 178 can engage with each other. The crimping portion is configured such that the upper crimping teeth 177 opens and closes with respect to (comes into contact with and separates from) the lower crimping teeth 178 by the driving force of the crimp-edge-binding clinch motor 176.

In the process of feeding the plurality of sheets P to be included in the sheet bundle Pb to the inner tray 114, the upper crimping teeth 177 and the lower crimping teeth 178 are separated from each other as illustrated in FIG. 4A. Then, when all the sheets P to be included in the sheet bundle Pb are placed on the inner tray 114 and predetermined alignment operation (operation of aligning the edges) is completed, the crimp-edge-binding processing unit 118 moves to a binding position, and the upper crimping teeth 177 and the lower crimping teeth 178 approach and engage with each other as illustrated in FIG. 4B. That is, the upper crimping teeth 177 and the lower crimping teeth 178 nip the sheet bundle Pb at a predetermined binding portion thereof to press and deform the sheet bundle Pb from the thickness direction. As a result, the sheet bundle Pb placed on the inner tray 114 is crimped and bound. Then, the sheet bundle Pb having been crimped and bound is ejected from the first ejection port 1101 toward the ejection tray 120 by the ejection roller pair 119.

The crimp-edge-binding processing unit 118 just needs to exert a function of pressurizing the sheet bundle Pb to crimp a specific portion. Therefore, the upper crimping teeth 177 and the lower crimping teeth 178 just need to be configured such that the upper crimping teeth 177 and the lower crimping teeth 178 can engage with each other to pressurize the sheet bundle Pb when the sheet bundle Pb is sandwiched between the upper crimping teeth 177 and the lower crimping teeth 178 to be bound. Therefore, a configuration that allows execution of the operation of closing the upper crimping teeth 177 and the lower crimping teeth 178 is not limited to the exemplary configuration disclosed in the present embodiment. For example, a link mechanism-type crimping mechanism may be used (for example, disclosed in Japanese Patent No. 6057167) which performs operation of causing the upper crimping teeth 177 and the lower crimping teeth 178 to approach (crimp) and separate from each other, by a drive source and a link mechanism that perform only forward rotation or forward and reverse rotation. In addition, a linear motion-type crimping mechanism may be used which causes the upper crimping teeth 177 and the lower crimping teeth 178 to linearly perform crimping and separating operation, by a screw mechanism that converts rotational motion of a drive source into linear motion.

In addition, as illustrated in FIG. 3, the crimping portion includes a binding-tooth slide mechanism for moving the upper crimping teeth 177 and the lower crimping teeth 178 relative to a frame of the crimp-edge-binding processing unit 118. The binding-tooth slide mechanism includes a binding-teeth slide motor 179 and a drive transmission mechanism.

The drive transmission mechanism serves as a linear-motion conversion mechanism, such as a rack-and-pinion mechanism or a crankshaft mechanism, which transmits the driving force of the binding-teeth slide motor 179. When the driving force from the binding-teeth slide motor 179 is transmitted to the upper crimping teeth 177 and the lower crimping teeth 178 by the drive transmission mechanism, the upper crimping teeth 177 and the lower crimping teeth 178 slide along respective longitudinal directions (longitudinal direction of the edge-stitching unit base member 151).

Here, the amount of slide movement of the upper crimping teeth 177 and the lower crimping teeth 178 is equivalent to, for example, a crimp mark length. Then, the upper crimping teeth 177 and the lower crimping teeth 178 perform a crimp binding multiple times before and after the slide movement. That is, when the length of each crimp mark by the upper crimping teeth 177 and the lower crimping teeth 178 is 10 mm, the amount of slide movement is also set to 10 mm. Thus, it is possible to obtain a crimp mark having a length of 20 mm in total by a crimping (first stroke) before the slide movement and a crimping (second stroke) after the slide movement. As a result, the binding force is improved about twofold.

### Outline of Binding Process

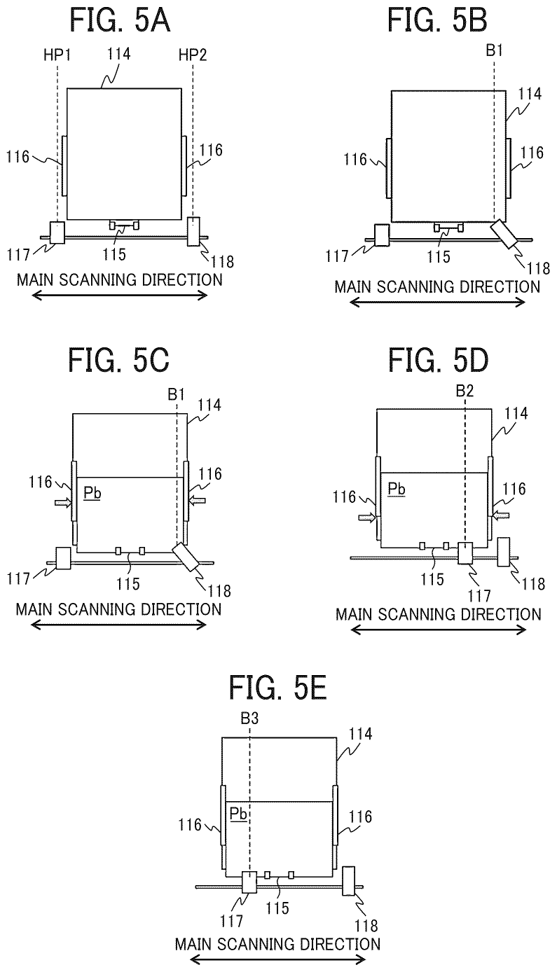

FIGS. 5A to 5E are diagrams illustrating positions of the staple-edge-binding processing unit 117 and the crimp-edge-binding processing unit 118 according to steps in the binding process. FIG. 5A illustrates a standby state for the binding process.

As illustrated in FIG. 5A, in the standby state, the staple-edge-binding processing unit 117 is located at a stapling standby position HP1. The crimp-edge-binding processing unit 118 is located at a crimp-binding standby position HP2.

FIGS. 5B and 5C illustrate a state in which an oblique-binding process is performed by the crimp-edge-binding processing unit 118.

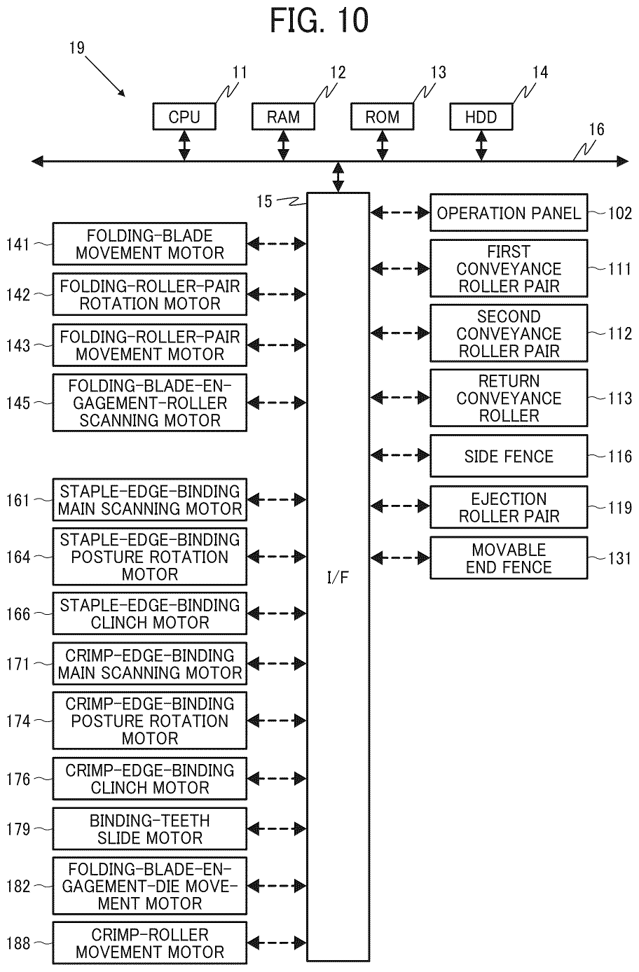

As illustrated in FIG. 5B, before a first sheet P1 to be included in the sheet bundle Pb is fed to the inner tray 114, the crimp-edge-binding processing unit 118 is moved in the main scanning direction and obliquely rotated so that the crimp-edge-binding processing unit 118 can face a first binding position B1. The movement and rotation of the crimp-edge-binding processing unit 118 are controlled by a controller 19 serving as a control device to be described below with reference to FIG. 10.

Subsequently, as illustrated in FIG. 5C, the controller 19 causes jogging operation to be executed each time the sheet P is conveyed to the inner tray 114, in a state where the crimp-edge-binding processing unit 118 has been disposed at a position where the crimp-edge-binding processing unit 118 faces the first binding position B1. The jogging operation is executed by the controller 19 performing control in such a way as to cause the side fences 116 to slide in the width direction.

Subsequently, in the state illustrated in FIG. 5C, the controller 19 repeats stacking and alignment operation of the sheets P until the number of sheets P to be included in the sheet bundle Pb reaches a predetermined number N.

Next, when detecting that the number of sheets P placed on the inner tray 114 has reached the predetermined number N, the controller 19 causes the crimp-edge-binding processing unit 118 to operate so as to perform a crimp binding at the first binding position B1 of the sheet bundle Pb placed on the inner tray 114.

Next, the controller 19 ejects, to the ejection tray 120, the sheet bundle Pb subjected to the crimp binding at the first binding position B1. Furthermore, the controller 19 moves the crimp-edge-binding processing unit 118 to the crimp-binding standby position HP2 illustrated in FIG. 5A.

FIGS. 5D and 5E illustrate a state in which a two-location-binding process is performed by the staple-edge-binding processing unit 117.

A second binding position B2 and a third binding position B3 are separated from each other in the main scanning direction. Before the first sheet P1 to be included in the sheet bundle Pb is fed to the inner tray 114, the controller 19 moves the staple-edge-binding processing unit 117 in the main scanning direction so that the staple-edge-binding processing unit 117 can face the second binding position B2. Next, as illustrated in FIG. 5D, the controller 19 causes the side fences 116 to execute jogging operation in a state where the staple-edge-binding processing unit 117 has been moved to a position where the staple-edge-binding processing unit 117 can face the second binding position B2.

Subsequently, in the state illustrated in FIG. 5D, the controller 19 repeats stacking and alignment operation of the sheets P until the number of sheets P to be included in the sheet bundle Pb reaches the predetermined number N.

Next, when detecting that the number of sheets P placed on the inner tray 114 has reached the predetermined number N, the controller 19 causes the staple-edge-binding processing unit 117 to operate so as to perform a stapling at the first binding position B1 of the sheet bundle Pb placed on the inner tray 114.

Next, as illustrated in FIG. 5E, the controller 19 causes the staple-edge-binding processing unit 117 to face the third binding position B3 and perform a stapling at the third binding position B3 of the sheet bundle Pb placed on the inner tray 114.

In the examples of FIGS. 5A to 5E, after binding is performed at the second binding position B2 in the two-location binding, binding is performed at the third binding position B3.

However, the order of execution of the two-location binding is not limited thereto. That is, the two-location binding may be executed such that the second binding position B2 is bound after the third binding position B3 is bound. In a case where the number of sheet bundles to be bound is continuous, for example, the third binding position B3 is bound after the second binding position B2 is bound for an odd-numbered sheet bundle, and the second binding position B2 is bound after the third binding position B3 is bound for an even-numbered sheet bundle. When the binding process is thus performed by rearrangement of the order of binding positions according to the order in the entire sheet bundles to be bound, efficiency of the binding process can be improved.

Next, the controller 19 ejects, to the ejection tray 120, the sheet bundle Pb stapled at the second binding position B2 and the third binding position B3. In addition, the controller 19 moves the staple-edge-binding processing unit 117 to the stapling standby position HP1 as illustrated in FIG. 5A.

The example of oblique binding of a corner of the sheet bundle Pb or two-location binding of two portions of the sheet bundle Pb has been described in the above embodiment. However, the present disclosure is also applicable to a case of binding three or more portions of the sheet bundle Pb separated in the main scanning direction.

### Outline of Crimp-Center-Binding Processing Unit

Here, referring back to FIG. 2, a detailed description will be given of a portion that performs a crimp center binding in the configuration of the post-processing apparatus 110. As illustrated in FIG. 2, the post-processing apparatus 110 includes a movable end fence 131, a folding blade 132, a folding roller pair 133, a folding-blade engagement roller 134, a center-folded booklet ejection roller pair 135, and a center-folded booklet ejection tray 136 in addition to the return conveyance roller 113, the inner tray 114, and the side fences 116.

The movable end fence 131, the folding blade 132, and the folding roller pair 133 form a center folder. Furthermore, the folding blade 132, the folding roller pair 133, and the folding-blade engagement roller 134 form a crimp center binder.

The movable end fence 131 is a mechanism that moves edges of the sheets P placed on the inner tray 114 in the conveyance direction and aligns a center-folding position with the position of the folding blade 132. The center-folding position is set in the vicinity of the center of the sheets P in the conveyance direction.

After the predetermined number N of sheets P to be included in the sheet bundle Pb are stacked on the inner tray 114 and the alignment process is completed, the movable end fence 131 moves to adjust the center-folding position of the sheet bundle Pb such that the center-folding position faces the folding blade 132. Alternatively, at the stage of placing the predetermined number N of sheets P to be included in the sheet bundle Pb, the position of the movable fence may be moved such that the center-folding position of the sheet bundle Pb faces the folding blade 132, and then the sheets P may be placed on the inner tray 114. In either case, adjustment is made such that the center-folding position on the sheet bundle Pb is set to a position where the sheet bundle Pb is pushed into the folding roller pair 133 by the folding blade 132. Then, in a state where these adjustments have been made, the crimp center binding is executed by operation of the folding blade 132, the folding roller pair 133, and the folding-blade engagement roller 134.

More specifically, the return conveyance roller 113 switchback-conveys the sheet P toward the movable end fence 131 at a timing when the sheet P conveyed from the image forming apparatus 101 is placed on the inner tray 114 after passing through the second conveyance roller pair 112. A series of steps leading to the switchback conveyance corresponds to a conveyance step. At this time, the movable end fence 131 may have already moved to a position corresponding to the center-folding position, or may be at the same position as the end fence 115.

A plurality of sheets P sequentially conveyed is temporarily placed on the inner tray 114. The movable end fence 131 is provided for the inner tray 114 such that the movable end fence 131 can move away from the end fence 115 in the conveyance direction. The movable end fence 131 is a member movable in the conveyance direction of the sheets P along the inner tray 114. The movable end fence 131 corresponds to a constituent element that is moved under the control of the controller 19 according to the conveyance direction length of the sheets P placed on the inner tray 114 (synonymous with the conveyance direction length in the switchback conveyance) to change the positions of the sheets P. The position of the movable end fence 131 is set such that a center position in the conveyance direction length of the sheets P faces the folding blade 132.

The side fences 116 align the sheets P or the sheet bundle Pb placed on the inner tray 114 in the main scanning direction (width direction). A crimp-center-binding processing unit performs the crimp center binding on the sheet bundle Pb aligned by the movable end fence 131 and the side fences 116. The sheet bundle Pb subjected to the crimp center binding is ejected by the center-folded booklet ejection roller pair 135, and is placed on the center-folded booklet ejection tray 136 via a second ejection port 1102.

### Operation of Crimp Center Binder

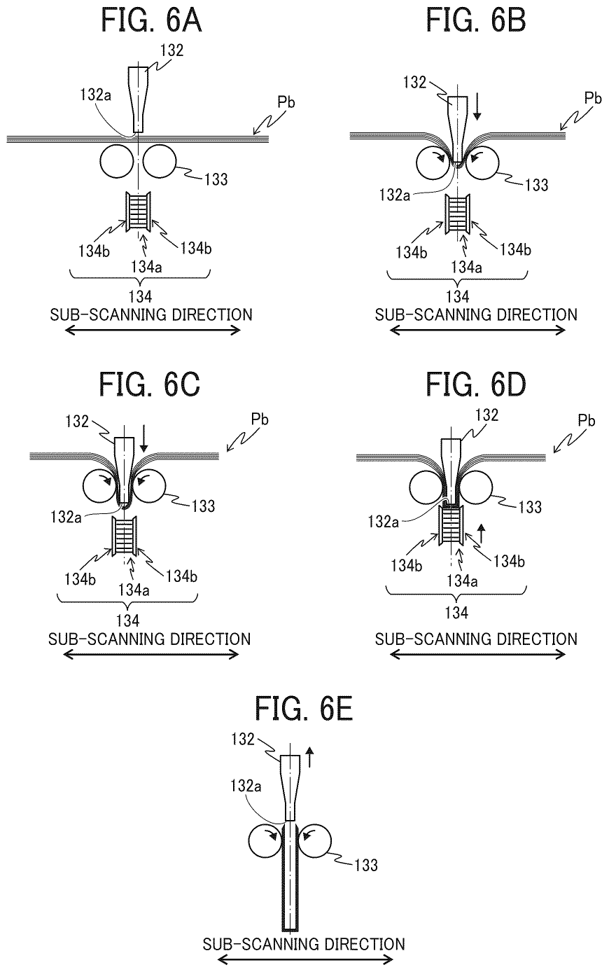

A description is given of the operation of the crimp center binder, with reference to FIGS. 6A to 6E.

FIGS. 6A to 6E are schematic diagrams mainly illustrating the folding blade 132 as a folding-plate member, the folding roller pair 133 as a folding-roller-pair member, and the folding-blade engagement roller 134 as a folding-plate engagement member, which form the crimp center binder.

FIGS. 6A to 6E illustrate an outline of center-folding binding to be executed by operation of these members. FIG. 6A illustrates a state in which after the conveyance step and a stacking step, the sheet bundle Pb is placed on the inner tray 114 and the edges of the sheets P are aligned, so that all the sheets P are aligned. In FIG. 6A, the folding blade 132, the folding roller pair 133, and the folding-blade engagement roller 134 are located at initial positions.

At the initial position, the folding blade 132 is substantially perpendicular to the sheet bundle Pb, and is separated from a surface of the sheet bundle Pb. At the initial position, the folding blade 132 faces a folding position at which the sheet bundle Pb is center-folded, and advances and retreats in the thickness direction of the sheet bundle Pb by a folding-blade movement motor 141 (FIG. 10) included in a folding-plate member moving mechanism. The folding blade 132 advances and retreats with respect to the sheet bundle Pb between a pushing position and a retracted position in a center-folding step of folding a center portion of the conveyance direction length as a part of the sheet bundle Pb. A fold portion is formed at the pushing position. The folding blade 132 is removed from the sheet bundle Pb at the retracted position after the center portion of the sheet bundle Pb is folded. The retracted position of the folding blade 132 corresponds to an initial position (HP position).

The folding roller pair 133 is disposed symmetrically with respect to a center line of the folding blade 132. That is, the folding roller pair 133 is disposed symmetrically with respect to the center line along a direction in which the folding blade 132 moves when performing a center-folding action on the sheets P. The folding roller pair 133 is rotated by a folding-roller-pair rotation motor 142 (see FIG. 10). In addition, the folding roller pair 133 has a configuration that allows the folding roller pair 133 to approach and separate from each other by a folding-roller-pair movement motor 143 (see FIG. 10) included in a pressurizing mechanism.

The distance between a pair of rollers included in the folding roller pair 133 is adjusted under the control of the controller 19. When the sheet bundle Pb is pushed toward the nip position of the folding roller pair 133 by the folding blade 132, the pair of rollers of the folding roller pair 133 is set to a “receiving position” under the control of the controller 19. At the receiving position, the nip position is separated according to a separation amount that is a predetermined amount. Note that before the center folding is started, the controller 19 may set the position of the folding roller pair 133 to a position where the folding roller pair 133 is separated from each other further than in the receiving position. The “receiving position” where the sheet bundle Pb is received is also regarded as a position where the folding roller pair 133 is located during standby in the center-folding binding. Thus, the receiving position also corresponds to a standby position.

The folding-blade engagement roller 134 included in a crimp binder is a cylindrical roller-shaped member. A rotation axis of the folding-blade engagement roller 134 is set in a direction passing through both ends sandwiching a cylindrical portion. The folding-blade engagement roller 134 is pivotally supported such that the folding-blade engagement roller 134 can rotate about the rotation axis. The folding-blade engagement roller 134 includes an engaging-crimping teeth portion 134a on the outer peripheral portion of the cylindrical portion (cylindrical outer peripheral surface). A plurality of teeth is disposed on the engaging-crimping teeth portion 134a. The folding-blade engagement roller 134 also includes flange portions 134b at both ends of the cylindrical portion. Each flange portion 134b has an outer diameter larger than the outer diameter of the engaging-crimping teeth portion 134a.

The flange portions 134b functioning as flange portions are equal in diameter at both ends of the cylindrical portion.

The engaging-crimping teeth portion 134a included in the folding-blade engagement roller 134 is a gear-shaped portion in which protrusions and recesses are repeatedly formed at predetermined intervals on the cylindrical outer peripheral surface of the folding-blade engagement roller 134 like a gear. The protrusions and recesses are formed in parallel with the rotation axis of the folding-blade engagement roller 134.

First, the center-folding step is executed in the crimp center binding according to the present embodiment. In the center-folding step, first, the controller 19 adjusts positions of the pair of rollers included in the folding roller pair 133 by the folding-roller-pair movement motor 143 to bring the sheet bundle Pb into a state where the sheet bundle Pb can be received. The folding-roller-pair movement motor 143 adjusts a gap at the nip position of the folding roller pair 133. The adjustment amount (separation amount) at this time is for forming a gap to such an extent that the folding blade 132 pushes an area in the vicinity of the conveyance direction (length direction) center of the sheet bundle Pb to the nip position (gap) of the folding roller pair 133 and that the folding blade 132 can advance in the nip position while pushing the sheet bundle Pb. Therefore, the adjustment amount of the gap at the receiving position of the folding roller pair 133 is changed according to, for example, the predetermined number N of sheets P to be included in the sheet bundle Pb and size information including the size and thickness of the sheet P.

In other words, as a previous stage of the center-folding step, when the folding blade 132 guides the sheet bundle Pb to a position between the rollers of the folding roller pair 133 (nip position), the controller 19 separates the rollers from each other so that the folding blade 132 and the sheet bundle Pb can pass between the rollers. For example, outer peripheries of the rollers are slightly separated from each other at the “receiving position” at which the rollers included in the folding roller pair 133 are located at this time.

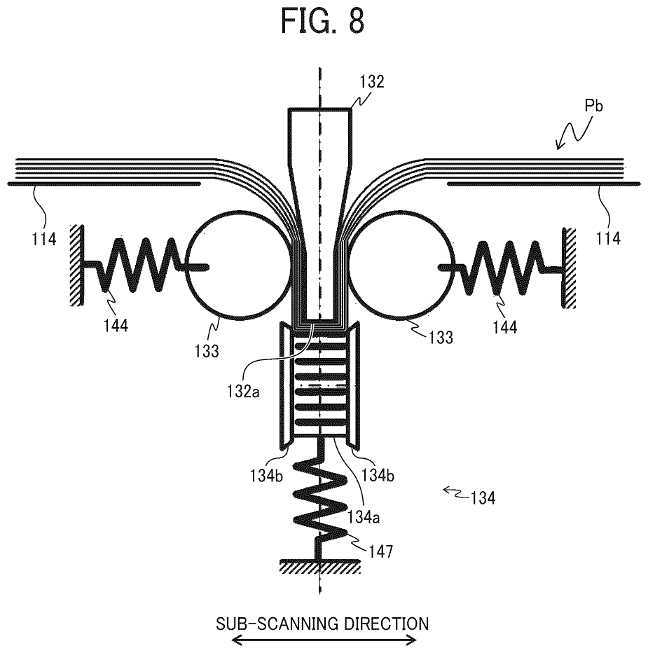

Subsequently, as illustrated in FIG. 6B, the folding blade 132 guides the sheet bundle Pb toward the nip position of the folding roller pair 133. At this time, the folding roller pair 133 is pressed against the sheet bundle Pb by the elastic force of a folding-roller-pair pressurizing member 144 (see FIG. 8). In other words, the degree to which the sheet bundle Pb is pressed by the folding blade 132 is determined by the elastic force of the folding-roller-pair pressurizing member 144. A fold portion is formed on the sheet bundle Pb by the pressing of the folding roller pair 133 to the sheet bundle Pb and the advancing of the folding blade 132.

Information for adjusting the receiving position of the folding roller pair 133 (type and thickness of sheet P and number of sheets P to be included in one unit of sheet bundle Pb) is preset in the controller 19 via an operation panel 102. That is, at the time of starting the center-folding step, the controller 19 calculates an adjustment value based on the number of sheets P to be included in the sheet bundle Pb that has already been set, the type of sheet P (mainly a difference in thickness), and the like, and then, adds the thickness of the folding blade 132 to the adjustment value. The controller 19 uses the value thus obtained as a gap adjustment amount.

As illustrated in FIG. 6B, the folding blade 132 as a rack-type crimping blade advances while pushing the sheet bundle Pb toward the folding roller pair 133 for which the gap has been adjusted. At this time, the folding roller pair 133 as the center folder rotates in accordance with the traveling speed of the folding blade 132 to press the sheet bundle Pb in a direction (the sub-scanning direction) orthogonal to the traveling direction of the folding blade 132. That is, the folding blade 132 and the sheet bundle Pb guided by the folding blade 132 that is advancing are pushed into the folding roller pair 133. When the sheet bundle Pb is pushed into the folding roller pair 133, the pushing position of the sheet bundle Pb is bent. Thus, the folding is executed. When the sheet bundle Pb is guided (pushed) between the folding roller pair 133 by the folding blade 132, the gap between the folding roller pair 133 is widened by an amount corresponding to a value twice as much as the thickness of the sheet bundle Pb.

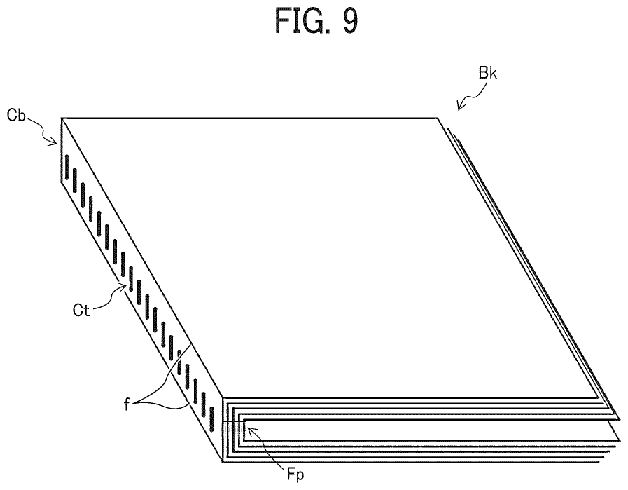

Furthermore, as illustrated in FIG. 6C, a tip of the folding blade 132 continues to advance to a position much beyond the nip position of the folding roller pair 133, and the center folding for the sheet bundle Pb proceeds. In this center folding, a part of the sheet bundle Pb (substantially central portion in the conveyance direction) serves as a fold portion Fp (see FIG. 9). When the center-folding step, which is the step illustrated in FIGS. 6B and 6C, is executed, the folding-blade engagement roller 134 is located at the retracted position separated from the tip of the folding blade 132 that has passed the nip position, as illustrated in FIG. 6C.

Subsequently, as illustrated in FIG. 6D, the folding-blade engagement roller 134 moves from the retracted position toward the folding blade 132. At this time, the folding-blade engagement roller 134 moves to an engagement position that is a position where the folding-blade engagement roller 134 and the folding blade 132 are in contact with each other via the sheet bundle Pb. When the folding-blade engagement roller 134 moves to the engagement position, a pressed state is established in which the sheet bundle Pb is sandwiched between the folding blade 132 and the folding-blade engagement roller 134. In this pressed state, the sheet bundle Pb is pressed from both sides such that a folding-crimping teeth portion 132a including the protrusions and recesses formed on the tip of the folding blade 132 and the engaging-crimping teeth portion 134a, which is a portion including the protrusions and recesses formed on the outer peripheral surface of the cylindrical portion of the folding-blade engagement roller 134, engage with each other, so that crimp binding is performed.

In addition, the sheet bundle Pb is bent in a direction opposite to the traveling direction of the folding blade 132 by the action of the flange portions 134b of the folding-blade engagement roller 134 and the folding blade 132 while a crimp bonding is being performed on the fold portion Fp of the sheet bundle Pb. The bending position (folding position) is defined by the flange portions 134b of the folding-blade engagement roller 134. Therefore, a back portion Cb of the sheet bundle Pb is formed with a width corresponding to the distance between the flange portions 134b of the folding-blade engagement roller 134 that is opposite to each other, with the center of the length of the sheet bundle Pb in the sheet conveyance direction as a starting point. Furthermore, folds “f” (see FIG. 9) as folding marks are formed at respective positions of the flange portions 134b of the folding-blade engagement roller 134. The folds “f” at this time are formed at two positions with a back portion Cb interposed therebetween. In other words, this process corresponds to a back-crimp binding process in which the back portion Cb is formed while forming the two folds “f” in parallel and, simultaneously or after the formation of the back portion Cb, the crimp binding is performed on the back portion Cb. The flange portions 134b of the folding-blade engagement roller 134 and the folding blade 132 corresponds to the back-portion former. Further, the folding blade 132 and the folding-blade engagement roller 134 correspond to the crimp binder. Further, the folding-crimping teeth portion 132a of the folding blade 132 and the engaging-crimping teeth portion 134a of the folding-blade engagement roller 134 form multiple streaks (crimp marks) substantially perpendicular to the folds “f”, in other words, crimp mark group Ct as illustrated in FIG. 9.

In other words, in a state where the sheet bundle Pb is pressed and nipped by the folding blade 132 and the folding-blade engagement roller 134, the controller 190 causes the folding-blade engagement roller 134 to move in the width direction (main scanning direction) of the sheet bundle Pb. At the time of the moving in the width direction, the folding-blade engagement roller 134 moves while rotating. In other words, the folding-blade engagement roller 134 moves while rotating in the width direction of the sheet bundle Pb in a state where the sheet bundle Pb is pressed against the folding blade 132. At this time, the flange portions 134b of the folding-blade engagement roller 134 nip the sheet bundle Pb protruding in a thickness direction of the folding-blade engagement roller 134, in such a way as to enclose the sheet bundle Pb. This operation causes a back portion Cb to be formed on the sheet bundle Pb and can perform crimp binding on the back portion Cb formed on the sheet bundle Pb simultaneously or after the back portion Cb is formed. In other words, the operation described with reference to FIG. 6D is a back crimp binding process that performs a back-portion forming process (back-folding process) and a crimp binding simultaneously.

Finally, as illustrated in FIG. 6E, the controller 19 retracts the folding-blade engagement roller 134 in the width direction of the sheet bundle Pb, and also retracts the folding blade 132 to the retracted position. Then, the controller 19 rotates the folding roller pair 133 to convey the sheet bundle Pb so as to cause the sheet bundle Pb to pass between the folding roller pair 133, and ejects a crimp-center-bound booklet with the back portion Cb subjected to crimp binding to the center-folded booklet ejection tray 136 (see FIG. 2).

As described above, in performing the crimp center binding on the sheet bundle Pb, the post-processing apparatus 110 according to the present embodiment first performs the center folding, and then performs a back-folding process of forming the back portion Cb of the center-folded sheet bundle Pb. Then, at the same time or after the back portion Cb is formed, the crimp-binding is performed on the back portion Cb. Thus, the center biding is completed. In other words, in the crimp-center-binding method as an embodiment of the sheet processing method according to the present disclosure, the back-portion forming process is performed subsequent to the center folding, and at the same time or after the back portion Cb is formed, a crimp-binding process (back-portion crimp binding process) is performed on the back portion Cb. As a result, unlike the conventional method, it is possible to form a crimp-center-bound booklet that can be easily opened without causing a crimp-bound portion to be peeled off by a folding process and a page turning action.

When the back-portion forming process and the crimp binding process are sequentially performed, for example, two rollers corresponding to the folding-blade engagement rollers 134 may be disposed, where one of the folding-blade engagement rollers 134 may have the engaging-crimping teeth portion 134a only and the other of the folding-blade engagement rollers 134 may have the flange portion 134b only. Due to such a configuration, the back-portion forming process and the crimp binding process can be performed in any desired order.

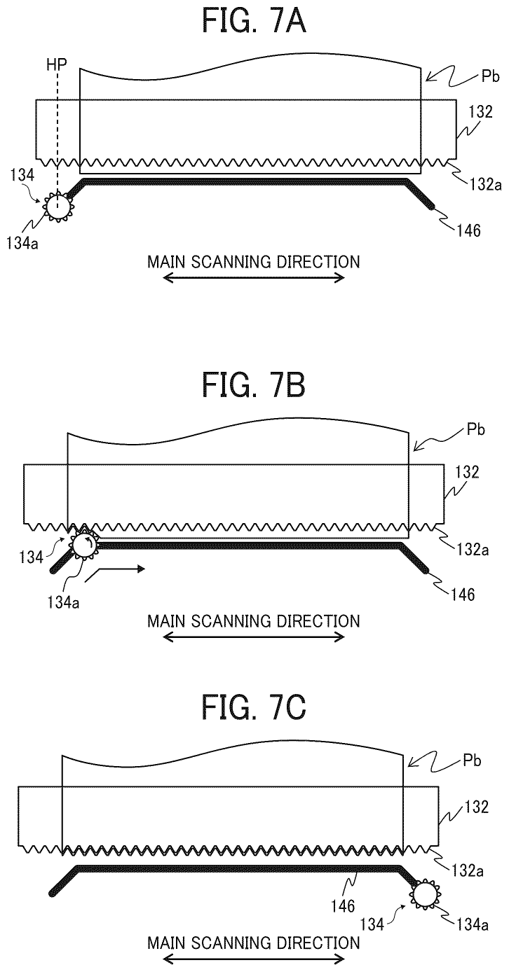

FIGS. 7A to 7C are cross-sectional views of the crimp center binder viewed from the sheet conveyance direction side at a center position of the thickness of the folding blade 132, which illustrate operation of the crimp center binder.

The center position of the thickness of the folding blade 132 corresponds to a center line of center folding. The folding blade 132 has a folding-crimping teeth portion 132a on a sheet-material pressing surface facing the folding-blade engagement roller 134 in the traveling direction. The folding-crimping teeth portion 132a serves as folding-plate crimping teeth having a protruding-recessed shape.

FIG. 7A corresponds to the state illustrated in FIG. 6C. As already described, in the state illustrated in FIG. 6C, the folding blade 132 pushes the sheet bundle Pb to a position beyond the nip position of the folding roller pair 133.

When the sheet bundle Pb is pushed into the nip position of the folding roller pair 133 by the folding blade 132 and travels, the folding-blade engagement roller 134 stands by at a position on the outer side of the length in the width direction of the sheet bundle Pb formed into a booklet in the center folding performed on the sheet bundle Pb. The standby position at this time corresponds to the initial position (HP position). The folding-blade engagement roller 134 at the initial position (HP position) is on the outer side in the main scanning direction with respect to the sheet bundle Pb that advances while being pushed into the nip position of the folding roller pair 133. Thus, the initial position (HP position) corresponds to a position where the folding-blade engagement roller 134 is in a separated state of being separated from the sheet bundle Pb. Among the constituent elements of the folding-blade engagement roller 134, only the engaging-crimping teeth portion 134a is illustrated in FIGS. 7A to 7C.

The folding-blade engagement roller 134 (engaging-crimping teeth portion 134a) is moved in the main scanning direction (the width direction of the sheet bundle Pb) by a folding-blade-engagement-roller scanning motor 145 (see FIG. 10). The crimp center binder is provided with an engagement-roller guide rail 146 as a folding-blade-engagement-roller contacting/separating mechanism. The engaging-crimping teeth portion 134a of the folding-blade engagement roller 134 moves in the main scanning direction along the engagement-roller guide rail 146.

The engagement-roller guide rail 146 is longer than the sheet bundle Pb in the main scanning direction, and portions located on the outer side of the edges of the sheet bundle Pb in the main scanning direction are separated from the fold portion of the sheet bundle Pb that has passed through the nip position of the folding roller pair 133. Furthermore, the engagement-roller guide rail 146 approaches the fold portion of the sheet bundle Pb that has passed through the nip position of the folding roller pair 133, in a portion located on the inner side of the edges of the sheet bundle Pb in the main scanning direction.

Therefore, the engaging-crimping teeth portion 134a of the folding-blade engagement roller 134 is out of contact with the fold portion formed on the sheet bundle Pb, at the edges of the sheet bundle Pb and on the outer side of the edges of the sheet bundle Pb in the main scanning direction, and moves such that the engaging-crimping teeth portion 134a and the folding blade 132 nip the fold portion on the inner side of the edges in the main scanning direction. Then, the engaging-crimping teeth portion 134a moves in the main scanning direction along the engagement-roller guide rail 146. As a result, points on the fold portion of the sheet bundle Pb at which the sheet bundle Pb is sandwiched between the engaging-crimping teeth portion 134a and the folding blade 132 are sequentially crimped and bound.

FIG. 7B corresponds to the state of FIG. 6D, and corresponds to a pressurized state in which the engaging-crimping teeth portion 134a of the folding-blade engagement roller 134 is pressed by the folding blade 132 to press and deform the sheet bundle Pb sandwiched between the engaging-crimping teeth portion 134a and the folding blade 132. When the folding-blade engagement roller 134 is at the fold portion of the sheet bundle Pb and scanning is performed while the back portion Cb is being formed by the folding-blade engagement roller 134, the folding roller pair 133 is in a pressurized state in which the sheet bundle Pb is nipped by the folding roller pair 133 and does not move so that the sheet bundle Pb is not pushed back. The controller 19 executes control so as to maintain the pressurized state of the folding roller pair 133. That is, when the crimp center binding is performed on the sheet bundle Pb, the folding roller pair 133 is controlled in such a way as to maintain the pressurized state so that the folding blade 132 does not retract by being pressurized by the folding-blade engagement roller 134.

Then, when the folding blade 132 is pressed by the folding-blade engagement roller 134, the teeth of the engaging-crimping teeth portion 134a engage with the folding-crimping teeth portion 132a in such a way as to nip the sheet bundle Pb. The engaging-crimping teeth portion 134a serves as engaging-crimping teeth of the folding-blade engagement roller 134.

The folding-crimping teeth portion 132a is provided on a pushing surface of the folding blade 132, and serves as folding-plate crimping teeth. As a result, the back portion Cb of the sheet bundle Pb is pressed and deformed in the main scanning direction to execute the back-crimp-binding process.

On the folding-crimping teeth portion 132a, protrusions and recesses are arranged at predetermined intervals in the main scanning direction as with rack teeth of a rack-and-pinion mechanism (see FIGS. 7A, 7B, and 7C). When the folding-blade engagement roller 134 is scanned in the main scanning direction by the folding-blade-engagement-roller scanning motor 145 (see FIG. 10), the position of engagement between the engaging-crimping teeth portion 134a of the folding-blade engagement roller 134 and the folding-crimping teeth portion 132a of the folding blade 132 moves in the main scanning direction. As the engaging position (engagement position) moves, the crimp binding is performed on the back portion Cb of the sheet bundle Pb. While the crimp binding is being performed, the folding roller pair 133 is kept pressed toward the nip position so that the folding-blade engagement roller 134 can reciprocate in the main scanning direction while maintaining the engagement position. This prevents the sheet bundle Pb and the folding blade 132 from escaping by being pressed by the folding-blade engagement roller 134.

As described above, when the engaging-crimping teeth portion 134a of the folding-blade engagement roller 134 approaches the back portion Cb formed on the sheet bundle Pb, the engaging-crimping teeth portion 134a moves in an oblique direction from the outer side in the width direction of the sheet bundle Pb toward the back portion Cb. As a result, the engaging-crimping teeth portion 134a of the folding-blade engagement roller 134 approaches from a direction in which the engaging-crimping teeth portion 134a does not collide with a width-directional end of the back portion Cb of the sheet bundle Pb, and the position of engagement with the folding-crimping teeth portion 132a of the folding blade 132 starts from the inner side of a width-directional edge of the sheet bundle Pb. As a result, the edge of the sheet bundle Pb can be prevented from being turned up when the folding-blade engagement roller 134 passes through the edge.

As illustrated in FIG. 7C, after the crimp binding is performed on the back portion Cb of the sheet bundle Pb, the engaging-crimping teeth portion 134a of the folding-blade engagement roller 134 passes to a position on the outer side of the other width-directional edge of the sheet bundle Pb in the main scanning direction (the edge opposite to the standby position), and moves to a position separated from the folding-crimping teeth portion 132a of the folding blade 132 in a center-folding ejection direction.

When the crimp center binding is successively performed on a next sheet bundle Pb, the engaging-crimping teeth portion 134a moves in a reverse direction in the main scanning direction. In other words, the engaging-crimping teeth portion 134a moves from left to right for an odd-numbered sheet bundle Pb in FIG. 7B, and the engaging-crimping teeth portion 134a moves from right to left for an even-numbered sheet bundle Pb in FIG. 7B.

The folding-blade-engagement-roller contacting/separating mechanism according to the present embodiment has been exemplified by the configuration including the engagement-roller guide rail 146 and the folding-blade-engagement-roller scanning motor 145 (see FIG. 10), but the mechanism is not limited thereto. A moving motor may be further provided which moves the folding-blade engagement roller 134 such that the folding-blade engagement roller 134 can advance and retract in the center-folding ejection direction.

FIG. 8 is a schematic diagram illustrating a state of the sheet bundle Pb being pressed by the crimp center binder.

As illustrated in FIG. 8, the folding blade 132 corresponds to a folding-plate member that guides a portion of the sheet bundle Pb placed and stacked on the inner tray 114 in a direction of the nip position of the folding roller pair 133 as a predetermined direction, the portion being in the vicinity of the center of the sheet bundle Pb in the conveyance direction.

In addition, the folding roller pair 133 corresponds to a folding-roller-pair member that nips the sheet bundle Pb guided by the folding blade 132 and traveling toward the nip position and further advances the sheet bundle Pb in the traveling direction.

In other words, the folding roller pair 133 is biased toward the folding blade 132 by the folding-roller-pair pressurizing member 144 such that the folding roller pair 133 nips the folding blade 132 and the sheet bundle Pb at the nip position. As a result of being biased in this manner, the folding roller pair 133 is put into a state of pressing the folding blade 132 that passes the nip position. The folding-roller-pair pressurizing member 144 is an elastic member such as a spring. Therefore, the folding-roller-pair pressurizing member 144 can be pushed back by elasticity while pressing the folding roller pair 133 toward the folding blade 132 when the folding blade 132 and the sheet bundle Pb travel between the folding roller pair 133 (nip position).

In the states of FIGS. 6B and 6C, the folding roller pair 133 conveys the sheet bundle Pb while pressing the sheet bundle Pb toward the folding blade 132. Therefore, the fold portion is pushed by a traveling-direction end of the folding blade 132 while the sheet bundle Pb is passing between the folding roller pair 133. Thus, the folding process is performed on the sheet bundle Pb. In addition, in the state of FIG. 6D, at the time of crimp binding, the sheet bundle Pb is held by the folding-blade engagement roller 134 in a state where the folding roller pair 133 presses the sheet bundle Pb.

The folding-blade engagement roller 134 is pressed toward the folding blade 132 by a folding-blade-engagement-roller pressurizing member 147 with the sheet bundle Pb being interposed the folding-blade engagement roller 134 and the folding blade 132. The folding-blade engagement roller 134 is a roller-shaped member, and is pivotally supported. The rotation axis of the folding-blade engagement roller 134 is an axis extending in a direction in which the folding roller pair 133 is biased by the folding blade 132.

The folding-blade engagement roller 134 includes the engaging-crimping teeth portion 134a and the flange portions 134b. The engaging-crimping teeth portion 134a is a cylindrical portion having a predetermined width in a rotation-axis direction. The flange portions 134b are flange portions provided at both ends of the cylindrical portion in the rotation-axis direction.

The engaging-crimping teeth portion 134a is biased by the folding-blade-engagement-roller pressurizing member 147 to press the sheet bundle Pb interposed between the engaging-crimping teeth portion 134a and the folding blade 132, and executes the crimp-binding process. Then, when being pressed toward the folding blade 132 by the engaging-crimping teeth portion 134a, portions of the sheet bundle Pb sandwiched between thickness-directional ends of the folding blade 132 and the flange portions 134b are directed in a direction along the folding blade 132. As a result, the portion of the sheet bundle Pb sandwiched between each flange portion 134b and the folding blade 132 is bent. This bending direction is opposite to a direction in which the folding blade 132 advances. At this time, a bent portion is formed at two positions spaced at a predetermined interval in the thickness direction of the folding blade 132. Thus, two fold lines are formed on the sheet bundle Pb by the crimp center binding. As a result, a square back is formed at a folded portion of the sheet bundle Pb, and the back portion Cb, which is a substantially flat portion, is formed between the fold lines. That is, square-back folding is executed by the back-portion crimp-binding process.

### Booklet Bk

FIG. 9 is a perspective view of a booklet Bk that exemplifies a booklet to be formed by the above-described crimp center binding.

As illustrated in FIG. 9, the sheet bundle Pb is bent at the fold portion Fp in the center folding performed on the sheet bundle Pb. Thus, the booklet Bk is formed, and a square back is formed on the back portion Cb. A crimp mark group Ct is formed on the back portion Cb at predetermined intervals in a longitudinal direction of the back portion Cb. The crimp mark group Ct is made as a result of pressure deformation by the engaging-crimping teeth portion 134a and the folding blade 132. The crimp mark group Ct can be formed at a position overlapping the position (fold portion Fp) where the sheet bundle Pb has been folded in the center-folding step performed on the sheet bundle Pb. In the booklet Bk, portions that move when the page turning action is performed correspond to the two folds “f” forming the back portion Cb. The two folds “f” are formed near both sides of the crimp mark group Ct.

Therefore, the booklet Bk to be formed in the center binding and the crimp-binding process according to the present embodiment has a structure to prevent a load from being applied to a crimped portion when a page turning action is made to turn a page at the folds “f”, and thus, has a structure in which a bound portion is not peeled off by the page turning action. In addition, since the folds “f” are formed at two positions with the back portion Cb interposed therebetween, either of the folds “f” formed at the two positions is movable in the page turning action. The fold “f” is at a position not overlapping with the fold portion Fp pushed into the nip position of the folding roller pair 133 by the folding blade 132. The fold portion Fp is at a binding position of the crimp-binding process.

Therefore, when page turning actions are performed, pages are turned at the folds “f”, and the fold portion Fp corresponding to a central portion of an opened booklet Bk is in a bound state. Therefore, no page is turned across the binding position. That is, since center-folding lines (folds “f”) are disposed symmetrically on both sides of the binding position, a double-page spread can be evenly formed. Thus, the quality of the booklet Bk is also maintained.

### Control Configuration

FIG. 10 is a hardware configuration diagram of the controller 19 that controls operation of the post-processing apparatus 110 according to the first embodiment.

As illustrated in FIG. 10, the controller 19 has a configuration in which a central processing unit (CPU) 11, a random access memory (RAM) 12, a read only memory (ROM) 13, a hard disk drive (HDD) 14, and an interface (I/F) 15 are connected via a common bus 16.

The CPU 11 is an arithmetic unit, and controls the entire operation of the post-processing apparatus 110. The RAM 12 is a volatile storage medium that allows information to be read and written at a high speed, and is used as a work area when the CPU 11 processes information. The ROM 13 is a read-only nonvolatile storage medium, and stores programs such as firmware. The HDD 14 is a nonvolatile storage medium that has a large storage capacity, and allows the reading and writing of information. An operating system (OS), various control programs, application programs, and the like are stored in the HDD 14.

The post-processing apparatus 110 processes, for example, a control program stored in the ROM 13 and an information processing program (application program) loaded from a storage medium such as the HDD 14 into the RAM 12, by an arithmetic function of the CPU 11. The processing implements a software control unit including various functional modules of the post-processing apparatus 110. A combination of the software control unit configured in this manner and hardware resources mounted on the post-processing apparatus 110 forms functional blocks that implement the function of the post-processing apparatus 110. That is, the CPU 11, the RAM 12, the ROM 13, and the HDD 14 form the controller 19 (control unit) that controls operation of the post-processing apparatus 110.

The I/F 15 is an interface that connects, to the common bus 16, the first conveyance roller pair 111, the second conveyance roller pair 112, the return conveyance roller 113, the side fences 116, the ejection roller pair 119, the movable end fence 131, the folding-blade movement motor 141, the folding-roller-pair rotation motor 142, the folding-roller-pair movement motor 143, the folding-blade-engagement-roller scanning motor 145, the staple-edge-binding main scanning motor 161, the staple-edge-binding posture rotation motor 164, the staple-edge-binding clinch motor 166, the crimp-edge-binding main scanning motor 171, the crimp-edge-binding posture rotation motor 174, the crimp-edge-binding clinch motor 176, the binding-teeth slide motor 179, a crimp-roller movement motor 188, and the operation panel 102.

The controller 19 causes the first conveyance roller pair 111, the second conveyance roller pair 112, the return conveyance roller 113, the side fences 116, the ejection roller pair 119, the movable end fence 131, the folding-blade movement motor 141, the folding-roller-pair rotation motor 142, the folding-roller-pair movement motor 143, the folding-blade-engagement-roller scanning motor 145, the staple-edge-binding main scanning motor 161, the staple-edge-binding posture rotation motor 164, the staple-edge-binding clinch motor 166, the crimp-edge-binding main scanning motor 171, the crimp-edge-binding posture rotation motor 174, the crimp-edge-binding clinch motor 176, the binding-teeth slide motor 179, and the crimp-roller movement motor 188 to operate, through the I/F 15.

As already described with reference to FIG. 1, the image forming apparatus 101 includes the operation panel 102. The operation panel 102 includes an operation device and a display (notification unit). The operation device receives an input operation from a user. The display notifies the user of information. The operation device includes, for example, physical input buttons and a touch screen overlaid on a display. Then, the operation panel 102 acquires information from the user through the operation device, and provides information to the user through the display. A specific example of the notification unit is not limited to the display and may be a light emitting diode (LED) lamp or a speaker. The post-processing apparatus 110 may include the same operation panel 102 as described above.

### First Modification

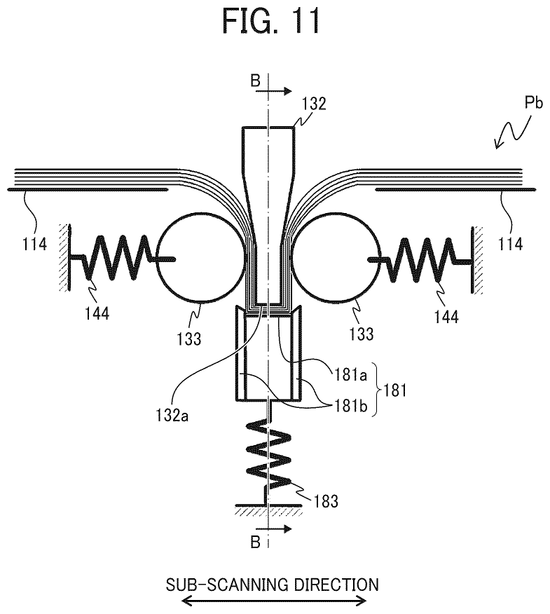

Next, a first modification of the crimp center binder will be described with reference to FIG. 11.

A crimp center binder according to the first modification differs from the crimp center binder according to the first embodiment in that a folding-blade engagement member includes a folding-blade engagement die 181 as a blade member extending in the main scanning direction (the longitudinal direction of the back portion Cb), instead of the folding-blade engagement roller 134 as a roller member that moves while rotating in the main scanning direction. Note that the constituent elements common to the crimp center binders according to the present modification and the first embodiment are denoted by the same reference numerals, and detailed description thereof will be omitted.

FIG. 11 is a schematic diagram illustrating the first modification of the crimp center binder. The folding roller pair 133 is pressed against each other by the folding-roller-pair pressurizing member 144 while nipping the folding blade 132 and the sheet bundle Pb.

In addition, the folding-blade engagement die 181 includes a die-crimping portion 181a having teeth as multiple engaging-crimping teeth groups in the longitudinal direction on the opposite surface to the folding blade 132. The folding blade 132 includes a folding-crimping teeth portion 132a as a folding-plate crimping teeth group on the opposite surface to the folding-blade engagement die 181. The folding-crimping teeth portion 132a engages with the die-crimping portion 181a as an engaging-crimping teeth group. When the folding blade 132 pushes the sheet bundle Pb to the folding roller pair 133 and the folds of the sheet bundle Pb reach the position at which the folding blade 132 and the folding-blade engagement die 181 can engage with each other, the folding-blade engagement die 181 moves toward the folding blade 132 to press the sheet bundle Pb to perform the crimp binding. At this time, the folding roller pair 133 is pressed toward the folding blade 132 by the folding-roller-pair pressurizing member 144, the folding blade 132 is prevented from being pushed back by the pressing force of the folding-blade engagement die 181 generated by the folding-roller-pair pressurizing member 183. Due to the pressing force of the folding-blade engagement die 181, the crimp binding by the die-crimping portion 181a of the folding-blade engagement die 181 is performed. As a result, the crimp mark group Ct including multiple crimp marks is formed in the longitudinal direction of the back portion Cb. The orientation of the crimp mark included in the crimp mark group Ct indicates a direction substantially perpendicular to the folds “f”. Further, by use of the pressing force of the folding-blade engagement die 181, the flange portions 181b of the folding-blade engagement die 181 can perform square-back folding on the sheet bundle Pb.

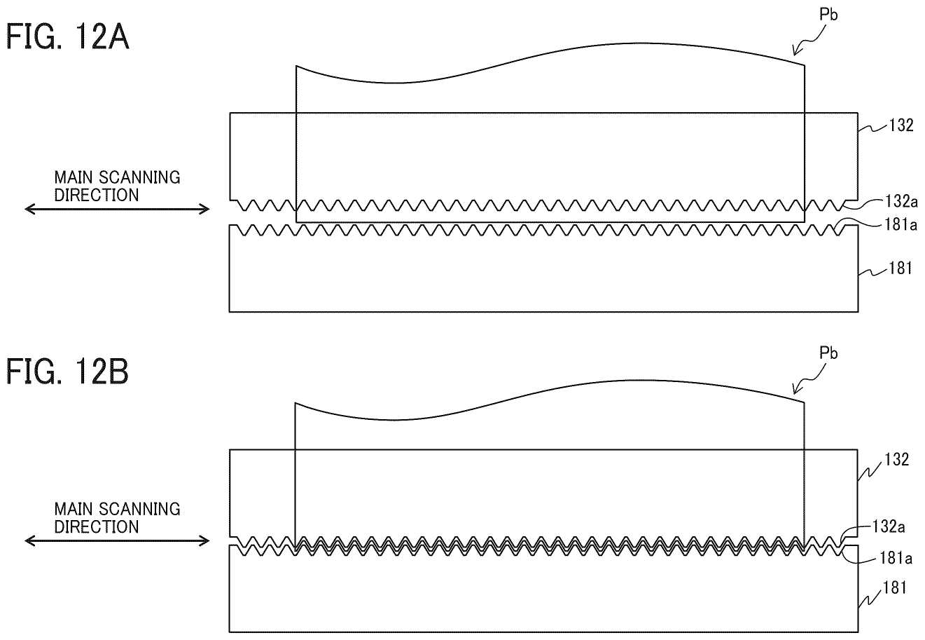

FIGS. 12A and 12B are cross-sectional views of the crimp center binder according to the first modification, which illustrate operation of the crimp center binder.

FIGS. 12A and 12B are cross-sectional views of the crimp center binder taken along line B-B as viewed from the sheet conveyance direction side at the center line of center folding, that is, at the center position of the thickness of the folding blade 132. FIG. 12A corresponds to the state of FIG. 6C. The folding blade 132 has pushed the sheet bundle Pb to a position beyond the nip position of the folding roller pair 133. The folding-blade engagement die 181 is located at the standby position (HP position), and is separated from the sheet bundle Pb in the center-folding ejection direction.

The folding-blade engagement die 181 is moved toward the folding blade by a folding-blade-engagement-die movement motor 182 (see FIG. 10).

FIG. 12B corresponds to the state of FIG. 6D. The folding-blade engagement die 181 is pressed against the folding blade 132 with the sheet bundle Pb interposed therebetween.

Thus, the teeth of the die-crimping portion 181a of the folding-blade engagement die 181 and the folding-crimping teeth portion 132a provided on the pushing surface of the folding blade 132 are engaged with each other with the sheet bundle Pb interposed therebetween. When the folding-blade engagement die 181 is pressurized by a folding-blade-engagement-die pressurizing member 183, the back portion of the sheet bundle Pb is crimped and bound.

### Second Modification

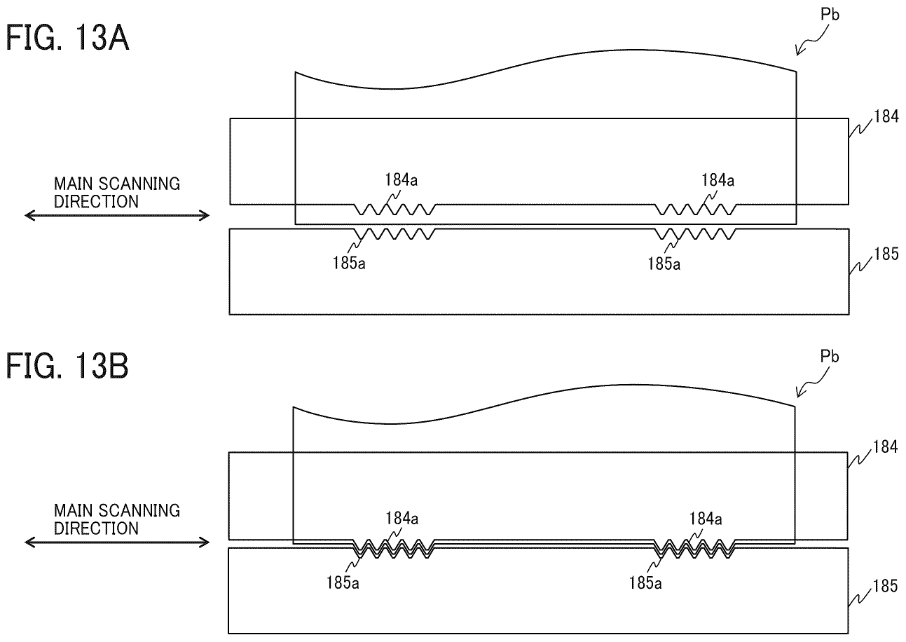

Next, a second modification of the crimp center binder will be described with reference to FIGS. 13A and 13B.

A crimp center binder according to the second modification differs from the crimp center binder according to the first modification in that crimping teeth in a protruding-recessed shape are not uniformly disposed in the width direction on a folding blade 184, but crimping tooth groups are partially (intermittently) disposed as folding-plate crimping tooth groups at a plurality of portions. Furthermore, in a folding-blade engagement die 185, crimping teeth groups are disposed as engaging-crimping tooth groups at positions facing the folding-plate crimping tooth groups. No engaging-crimping tooth group is disposed at a substantially flat portion. Note that constituent elements common to the crimp center binders according to the present modification and the first embodiment are denoted by the same reference numerals, and detailed description thereof will be omitted.

FIGS. 13A and 13B are cross-sectional views of the crimp center binder according to the second modification, which illustrate operation of the crimp center binder.

FIGS. 13A and 13B are cross-sectional views of the crimp center binder according to the second modification viewed from the sheet conveyance direction side at the center line of center folding, that is, at the center position of the thickness of the folding blade 132.

FIG. 13A corresponds to the state of FIG. 6C. A folding blade 184 has pushed the sheet bundle Pb to a position beyond the nip position of the folding roller pair 133. A folding-blade engagement die 185 is located at the standby position (HP position), and is separated from the sheet bundle Pb in the center-folding ejection direction.

The folding-blade engagement die 185 is moved toward the folding blade by the folding-blade-engagement-die movement motor 182 (see FIG. 10).

FIG. 13B corresponds to the state of FIG. 6D. The folding-blade engagement die 185 is pressed against the folding blade 184 with the sheet bundle Pb interposed therebetween. Thus, the teeth of a crimping portion 185a of the folding-blade engagement die 185 and the teeth of a crimp teeth portion 184a provided on a pushing surface of the folding blade 184 are engaged with each other with the sheet bundle Pb interposed therebetween. When the folding-blade engagement die 185 is pressurized by the folding-blade-engagement-die pressurizing member 183, the back portion of the sheet bundle Pb is crimped and bound.

### Third Modification

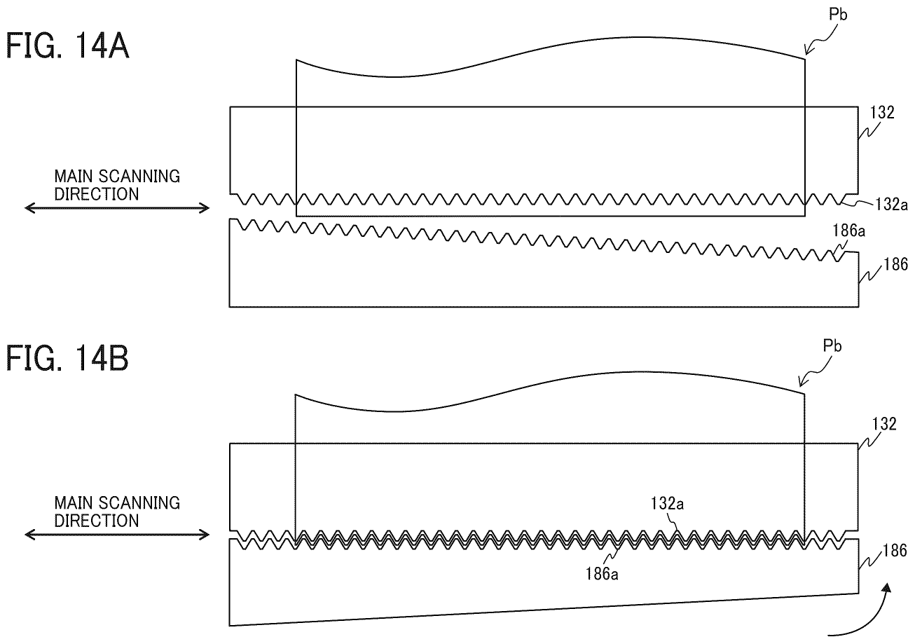

Next, a third modification of the crimp center binder will be described with reference to FIGS. 14A and 14B.

A crimp center binder according to the third modification differs from the crimp center binder according to the first modification in that a folding-blade engagement member is configured such that the folding-blade engagement member (a folding-blade engagement die 186) does not linearly move to and engage with the folding blade 132 while facing the folding blade 132, but moves on a rotational trajectory so that crimping teeth in a protruding-recessed shape sequentially engage with each other. Note that constituent elements common to the crimp center binders according to the present modification and the first embodiment are denoted by the same reference numerals, and detailed description thereof will be omitted.

FIGS. 14A and 14B are cross-sectional views of the crimp center binder according to the third modification, which illustrate operation of the crimp center binder.

FIGS. 14A and 14B are cross-sectional views of the crimp center binder according to the third modification viewed from the sheet conveyance direction side at the center line of center folding, that is, at the center position of the thickness of the folding blade 132.

FIG. 14A corresponds to the state of FIG. 6C. The folding blade 132 has pushed the sheet bundle Pb to a position beyond the nip position of the folding roller pair 133. A folding-blade engagement die 186 is located at the standby position (HP position), and is separated from the sheet bundle Pb in the center-folding ejection direction.

The folding-blade engagement die 186 is moved toward the folding blade 132 by the folding-blade-engagement-die movement motor 182 (see FIG. 10), and is moved on a rotational trajectory so that the teeth of the crimping portion 186a of the folding-blade engagement die 186 sequentially engage with the teeth of the folding-crimping teeth portion 132a of the folding blade 132.

FIG. 14B corresponds to the state of FIG. 6D. The folding-blade engagement die 186 is pressed against the folding blade 132 with the sheet bundle Pb interposed therebetween. Thus, the teeth of a crimping portion 186a of the folding-blade engagement die and the teeth of the folding-crimping teeth portion 132a provided on the pushing surface of the folding blade 132 are engaged with each other with the sheet bundle Pb interposed therebetween. When the folding-blade engagement die 186 is pressurized by the folding-blade-engagement-die pressurizing member 183, the back portion of the sheet bundle Pb is crimped and bound.

The crimping portion 186a of the folding-blade engagement die 186 is not a flat surface but a curved surface. Thus, the teeth of the crimping portion 186a may be provided on the curved surface, and the crimping portion 186a of the folding-blade engagement die 186 may be moved on a rotational trajectory so that the teeth of the crimping portion 186a of the folding-blade engagement die 186 sequentially engage with the teeth of the folding-crimping teeth portion 132a of the folding blade 132.

As described above, the teeth of the crimping portion 186a of the folding-blade engagement die 186 sequentially engage with the teeth of the folding-crimping teeth portion 132a of the folding blade 132. As a result, the pressurizing force to be applied at the time of crimp binding can be reduced, and thus, the apparatus can be downsized.

### Fourth Modification

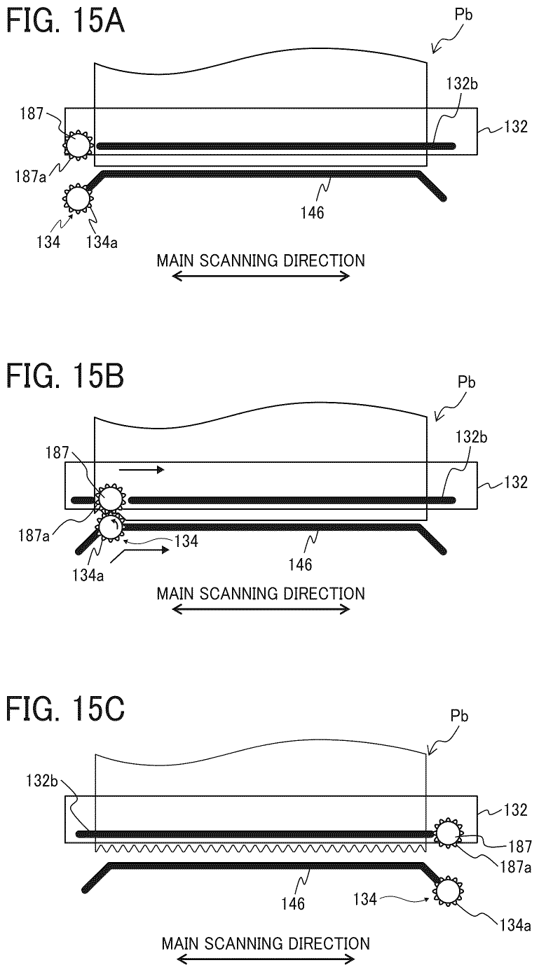

Next, a fourth modification of the crimp center binder will be described with reference to FIGS. 15A to 15C.

A crimp center binder according to the fourth modification differs from the crimp center binder according to the first embodiment in that the folding blade 132 includes a crimp roller 187 having teeth disposed on an outer periphery to be movable at a tip portion in the main scanning direction. Note that constituent elements common to the crimp center binders according to the present modification and the first embodiment are denoted by the same reference numerals, and detailed description thereof will be omitted.

FIGS. 15A to 15C are cross-sectional views of the crimp center binder according to the fourth modification, which illustrate operation of the crimp center binder.

FIGS. 15A to 15C are cross-sectional views of the crimp center binder according to the fourth modification viewed from the sheet conveyance direction side at the center line of center folding, that is, at the center position of the thickness of the folding blade 132. FIG. 15A corresponds to the state of FIG. 6C. The folding blade 132 has pushed the sheet bundle Pb to a position beyond the nip position of the folding roller pair 133. The folding-blade engagement roller 134 and the crimp roller 187 are located at the standby position (HP position), and are separated from the sheet bundle Pb in the center-folding ejection direction.

The crimp roller 187 serving as a first roller member is supported in such a way as to be guided by a crimp-roller rail 132b. The crimp-roller rail 132b is disposed in a longitudinal direction (main scanning direction) of the folding blade 132. The crimp roller 187 is moved in the main scanning direction of the sheet bundle Pb by the crimp-roller movement motor 188 (see FIG. 10).

FIG. 15B corresponds to the state of FIG. 6D. The folding-blade engagement roller 134 serving as a second roller member is guided by the engagement-roller guide rail 146, approaches the crimp roller 187, and is pressed against the crimp roller 187 via the sheet bundle Pb. The teeth of the engaging-crimping teeth portion 134a of the folding-blade engagement roller and teeth 187a provided on a pushing surface of the crimp roller 187 are engaged with each other with the sheet bundle Pb interposed therebetween. At the time, the folding-blade engagement roller 134 is pressurized by the folding-blade-engagement-roller pressurizing member 147. As a result, the teeth of the engaging-crimping teeth portion 134a of the folding-blade engagement roller 134 and the teeth of a crimping portion 187a provided on a pushing surface of the crimp roller 187 press and deform the sheet bundle Pb. By so doing, the back portion Cb of the sheet bundle Pb is crimped and bound.

### Fifth Modification

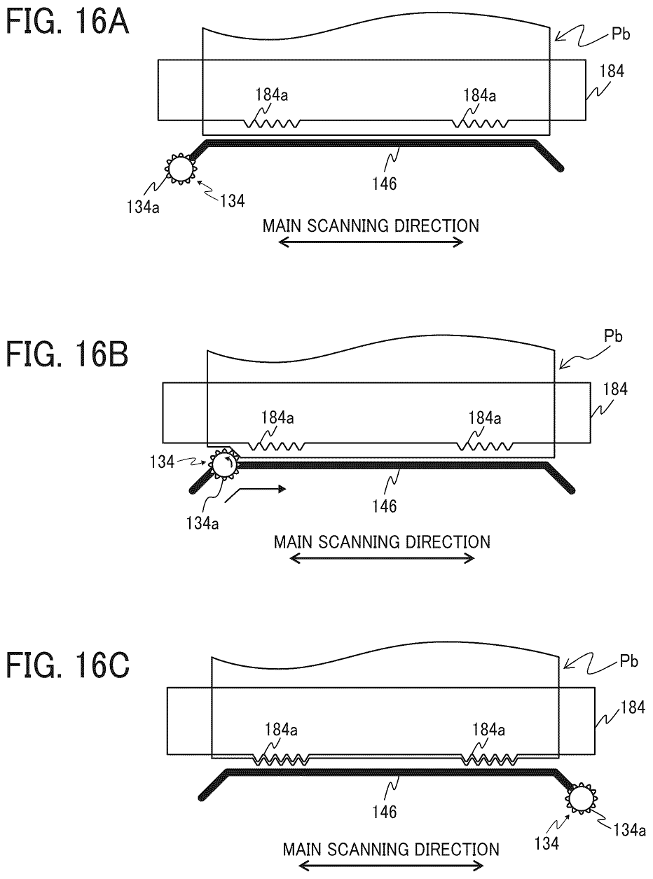

Next, a fifth modification of the crimp center binder will be described with reference to FIGS. 16A to 16C.

A crimp center binder according to the fifth modification differs from the crimp center binder according to the first embodiment in that the crimping teeth of the folding blade in a protruding-recessed shape are not uniformly disposed in the main scanning direction, but are partially (intermittently) disposed. Note that constituent elements common to the crimp center binders according to the present modification and the first embodiment are denoted by the same reference numerals, and detailed description thereof will be omitted.

FIGS. 16A to 16C are cross-sectional views of the crimp center binder according to the fifth modification, which illustrate operation of the crimp center binder.

FIGS. 16A to 16C are cross-sectional views of the crimp center binder according to the fifth modification viewed from the sheet conveyance direction side at the center line of center folding, that is, at the center position of the thickness of the folding blade 184.

FIG. 16A corresponds to the state of FIG. 6C. The folding blade 184 has pushed the sheet bundle Pb to a position beyond the nip position of the folding roller pair 133. The folding-blade engagement roller 134 is located at the standby position (HP position), and is separated from the sheet bundle Pb in the center-folding ejection direction.

Thus, the teeth of the engaging-crimping teeth portion 134a of the folding-blade engagement roller 134 and the folding-crimping teeth portion 184a provided on the pushing surface of the folding blade 184 are engaged with each other with the sheet bundle Pb interposed therebetween. When the folding-blade engagement roller 134 is pressurized by the folding-blade-engagement-roller pressurizing member 147, the back portion of the sheet bundle Pb is crimped and bound.

FIG. 16B corresponds to the state of FIG. 6D. The folding-blade engagement roller 134 is pressed against the folding blade 184 with the sheet bundle Pb interposed therebetween.

Thus, the teeth of the engaging-crimping teeth portion 134a of the folding-blade engagement roller 134 and the teeth of the crimping-teeth portion 184a provided on the pushing surface of the folding blade 184 are engaged with each other with the sheet bundle Pb interposed therebetween. At the time of the engagement of the teeth of the engaging-crimping teeth portion 134a of the folding-blade engagement roller 134 and the teeth of the crimping-teeth portion 184a of the folding blade 184, the folding-blade engagement roller 134 is pressed by the folding-blade-engagement-roller pressurizing member 147. As a result, the teeth of the engaging-crimping teeth portion 134a of the folding-blade engagement roller 134 and the teeth of a crimping portion 187a of the crimp roller 187 press and deform the sheet bundle Pb. By so doing, the back portion Cb of the sheet bundle Pb is crimped and bound.

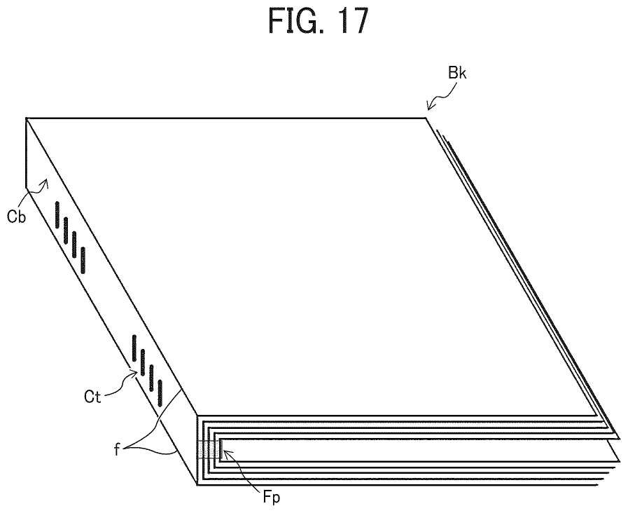

FIG. 17 is a schematic view of a booklet Bk formed in the fifth modification.

As illustrated in FIG. 17, the back portion Cb of the booklet Bk has a square back. Then, the back portion Cb is crimped and bound at predetermined intervals, and the crimp mark group Ct is formed in the longitudinal direction of the back portion Cb (width direction of the sheet bundle Pb) at predetermined intervals.

### Sixth Modification

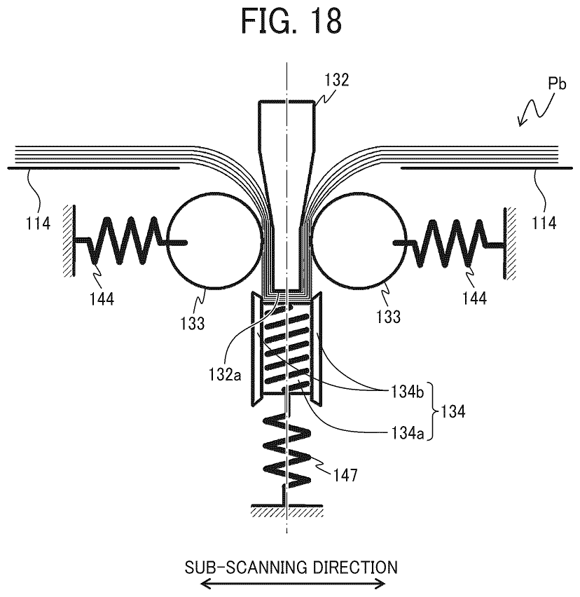

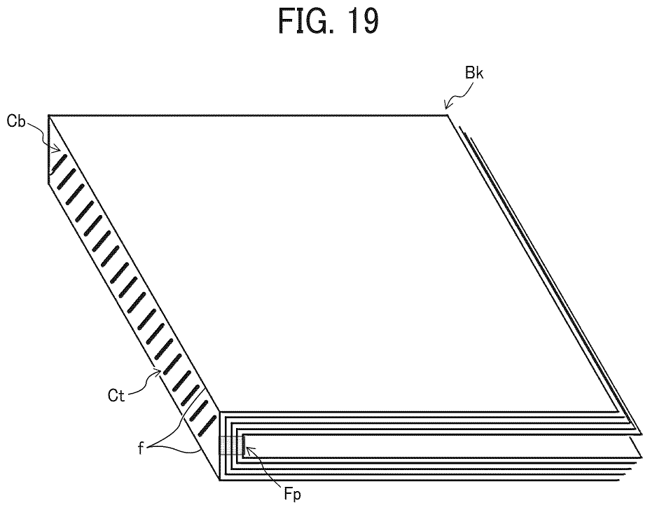

Next, a sixth modification of the crimp center binder will be described with reference to FIGS. 18 and 19.

A crimp center binder according to the sixth modification differs from the crimp center binder according to the first embodiment in that the teeth of the engaging-crimping teeth portion 134a of the folding-blade engagement roller 134 are not arranged in parallel in the main scanning direction, but are formed in, for example, a “helical-tooth shape” arranged to be inclined with respect to the main scanning direction. Here, the teeth of the engaging-crimping teeth portion 134a are inclined at an angle of, for example, 15 degrees. Note that the constituent elements common to the crimp center binders according to the present modification and the first embodiment are denoted by the same reference numerals, and detailed description thereof will be omitted.

FIG. 19 is a schematic view of a crimp-center-bound booklet bound in the sixth modification. As illustrated in FIG. 19, the back portion Cb of the booklet Bk has a square back. Then, the back portion Cb is crimped and bound, and each crimp marks included in the crimp mark group Ct are aligned to be inclined in the longitudinal direction of the back portion Cb (the width direction of the sheet bundle Pb).

### Seventh Modification

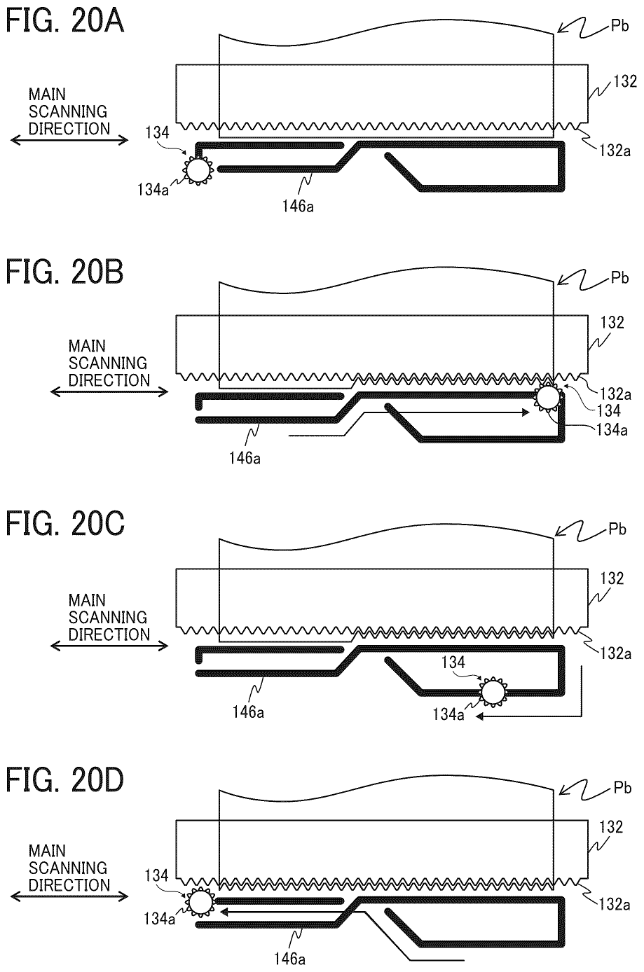

Next, a seventh modification of the crimp center binder will be described with reference to FIGS. 20A to 20D.

A crimp center binder according to the seventh modification differs from the crimp center binder according to the first embodiment in that the folding-blade engagement roller 134 performs scanning on a figure-eight trajectory. Note that constituent elements common to the crimp center binders according to the present modification and the first embodiment are denoted by the same reference numerals, and detailed description thereof will be omitted.

FIGS. 20A to 20D are cross-sectional views of the crimp center binder according to the seventh modification, which illustrate operation of the crimp center binder.

FIGS. 20A to 20D are cross-sectional views of the crimp center binder according to the seventh modification viewed from the sheet conveyance direction side at the center line of center folding, that is, at the center position of the thickness of the folding blade 132.

FIG. 20A corresponds to the state of FIG. 6C. The folding blade 132 has pushed the sheet bundle Pb to a position beyond the nip position of the folding roller pair 133. The folding-blade engagement roller 134 is located at the standby position (HP position), and is separated from the sheet bundle Pb in the center-folding ejection direction.

The folding-blade engagement roller 134 is supported by an engagement-roller guide rail 146a. The folding-blade engagement roller 134 is moved along the engagement-roller guide rail 146a by the folding-blade-engagement-roller scanning motor 145 (see FIG. 10). The movement of the folding-blade engagement roller 134 is controlled by the controller 19 (FIG. 10).

The engagement-roller guide rail 146a is disposed in such a way as to connect a position where the engaging-crimping teeth portion 134a of the folding-blade engagement roller 134 engages with the folding-crimping teeth portion 132a of the folding blade 132 and a position where the engaging-crimping teeth portion 134a is separated from the folding blade 132.

Since the engagement-roller guide rail 146a is provided, the folding-blade engagement roller 134 approaches the folding blade 132 in a predetermined section in the longitudinal direction of the folding blade 132, and separates from the folding blade 132 in another section.

FIG. 20B corresponds to the state of FIG. 6D. The folding-blade engagement roller 134 is guided by the engagement-roller guide rail 146a and pressed toward the folding blade 132 with the sheet bundle Pb interposed between the folding-blade engagement roller 134 and the folding blade 132 from a first predetermined position in the width direction of the sheet bundle Pb. At this time, the teeth of the engaging-crimping teeth portion 134a of the folding-blade engagement roller and the folding-crimping teeth portion 132a provided on the pushing surface of the folding blade 132 are engaged with each other with the sheet bundle Pb interposed therebetween. When the folding-blade engagement roller 134 is pressurized by the folding-blade-engagement-roller pressurizing member 147, the back portion Cb of the sheet bundle Pb is crimped and bound.

As illustrated in FIG. 20B, the folding-blade engagement roller 134 is guided by the engagement-roller guide rail 146a to move in the main scanning direction to a retracted position where the folding-blade engagement roller 134 passes through an edge of the sheet bundle, and crimps and binds substantially half of a region of the sheet bundle Pb in the width direction.

Subsequently, as illustrated in FIG. 20C, the folding-blade engagement roller 134 is guided by the engagement-roller guide rail 146a, is separated again from the sheet bundle Pb at the retracted position, and moves in a reverse direction in the main scanning direction.

Subsequently, as illustrated in FIG. 20D, the folding-blade engagement roller 134 is guided by the engagement-roller guide rail 146a, and moves in the main scanning direction while pressing the sheet bundle Pb again from a second predetermined position until the folding-blade engagement roller 134 passes through the other edge of the sheet bundle Pb.

The folding-blade engagement roller 134 is guided by the engagement-roller guide rail 146a and moves along a figure-eight trajectory. Thus, the entire region in the longitudinal direction of the back portion Cb is crimped and bound.

The folding-blade engagement roller 134 presses and deforms the back portion Cb of the sheet bundle Pb to perform crimp binding and square-back folding. Since the folding-blade engagement roller 134 sequentially performs the crimp binding and the square-back folding while moving in the main scanning direction, the pressing force can be concentrated on a point of processing. As a result, the pressing force can be reduced, and thus, the apparatus can be downsized. Meanwhile, when unintended deformation (for example, sheet wrinkle) of the sheet bundle Pb occurs, sheet wrinkles may be accumulated and enlarged as moving in the main scanning direction.

The folding-blade engagement roller 134 moves along the figure-eight trajectory. As a result, it is possible to process a front half region of the sheet width from a central portion toward one edge, first, and then process a back half region from the central portion toward the other edge. By so doing, even in a case where unintended deformation (for example, sheet wrinkle) of the sheet bundle Pb occurs, it is possible to reduce accumulation of sheet wrinkles to half.

### Eighth Modification

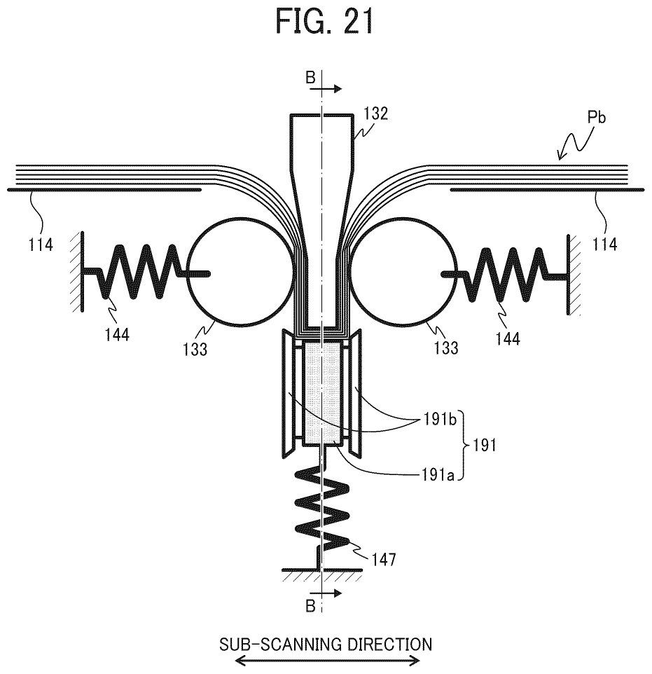

Next, an eighth modification of the crimp center binder will be described with reference to FIG. 21.

A crimp center binder according to the eighth modification differs from the crimp center binder according to the first embodiment in that no crimping teeth portion having a protruding-recessed shape is provided on the pressing surface of the folding blade 132, no constituent element such as the folding-crimping teeth portion 132a serving as a folding-crimping teeth portion having a protruding-recessed shape is provided on the cylindrical outer peripheral portion of the folding-blade engagement roller, and instead, a heating unit is provided on the cylindrical outer peripheral portion of a folding-blade engagement roller 191. Note that constituent elements common to the crimp center binders according to the present modification and the first embodiment are denoted by the same reference numerals, and detailed description thereof will be omitted.

FIG. 21 is a schematic diagram illustrating the eighth modification of the crimp center binder. The folding roller pair 133 is pressed against each other by the folding-roller-pair pressurizing member 144 while nipping the folding blade 132 and the sheet bundle Pb.

Furthermore, the folding-blade engagement roller 191 serving as a folding-plate engagement heating member according to the present modification is pressed by the folding-blade-engagement-roller pressurizing member 147 toward the folding blade 132 with the sheet bundle Pb interposed between the folding-blade engagement roller 191 and the folding blade 132. By use of the pressing force and the heat, toner-crimp binding is performed on the sheet bundle Pb by a heat-crimping portion 191a of the folding-blade engagement roller 191 and the folding blade 132. Then, the back-portion forming process of performing square-back folding on the sheet bundle Pb can be performed by flange portions 191b formed at both ends of a cylindrical portion of the folding-blade engagement roller 191.

The folding-blade engagement roller 191 forming a toner crimp binder is a cylindrical roller-shaped member. A rotation axis of the folding-blade engagement roller 191 is set in a direction passing through both ends sandwiching the cylindrical outer peripheral portion of the folding-blade engagement roller 191. The folding-blade engagement roller 191 is pivotally supported such that the folding-blade engagement roller 191 can rotate around the rotation axis as a rotation center. The folding-blade engagement roller 191 includes the heat-crimping portion 191a on the cylindrical outer peripheral portion (cylindrical outer peripheral surface). The folding-blade engagement roller 191 also includes the flange portions 191b having an outer diameter larger than the outer diameter of the heat-crimping portion 191a at both ends of the cylindrical outer peripheral surface. The flange portions 191b are equal in diameter at both ends of the cylindrical outer peripheral surface.

The heat-crimping portion 191a of the folding-blade engagement roller 191 is a portion heated by a heater installed inside the folding-blade engagement roller 191.

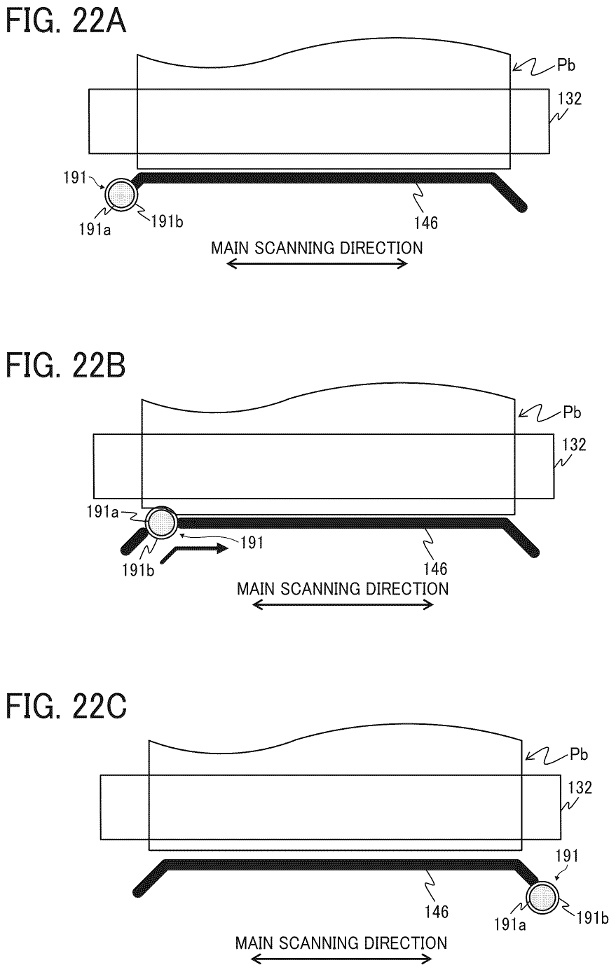

FIGS. 22A to 22C are cross-sectional views of the crimp center binder according to the eighth modification, which illustrate operation of the crimp center binder.

FIGS. 22A to 22C are cross-sectional views of the crimp center binder taken along line B-B in FIG. 21, as viewed from the sheet conveyance direction side at the center line of center folding, that is, at the center position of the thickness of the folding blade 132.

FIG. 22A corresponds to the state of FIG. 6C. The folding blade 132 has pushed the sheet bundle Pb to a position beyond the nip position of the folding roller pair 133. The folding-blade engagement roller 191 is located at the standby position (HP position), and is separated from the sheet bundle Pb in the center-folding ejection direction.

The folding-blade engagement roller 191 (heat-crimping portion 191a) is moved in the main scanning direction (the width direction of the sheet bundle Pb) by the folding-blade-engagement-roller scanning motor 145 (see FIG. 10). The crimp center binder is provided with the engagement-roller guide rail 146 as a folding-blade-engagement-roller contacting/separating mechanism. The folding-blade engagement roller 191 moves in the main scanning direction along the engagement-roller guide rail 146.

FIG. 22B corresponds to the state of FIG. 6D. The folding-blade engagement roller 191 is pressed against the folding blade 132 with the sheet bundle Pb interposed therebetween, and the heat-crimping portion 191a of the folding-blade engagement roller is pressed against the pushing surface of the folding blade 132 to be heated and pressurized with the sheet bundle Pb interposed therebetween. As a result, the back portion Cb of the sheet bundle Pb is crimped and bound.

FIG. 22C illustrates a state in which the folding-blade engagement roller 191 crimps and binds the entire region of the back portion Cb of the sheet bundle Pb in the longitudinal direction, and then the folding-blade engagement roller 191 is separated from the sheet bundle Pb in the center-folding ejection direction.

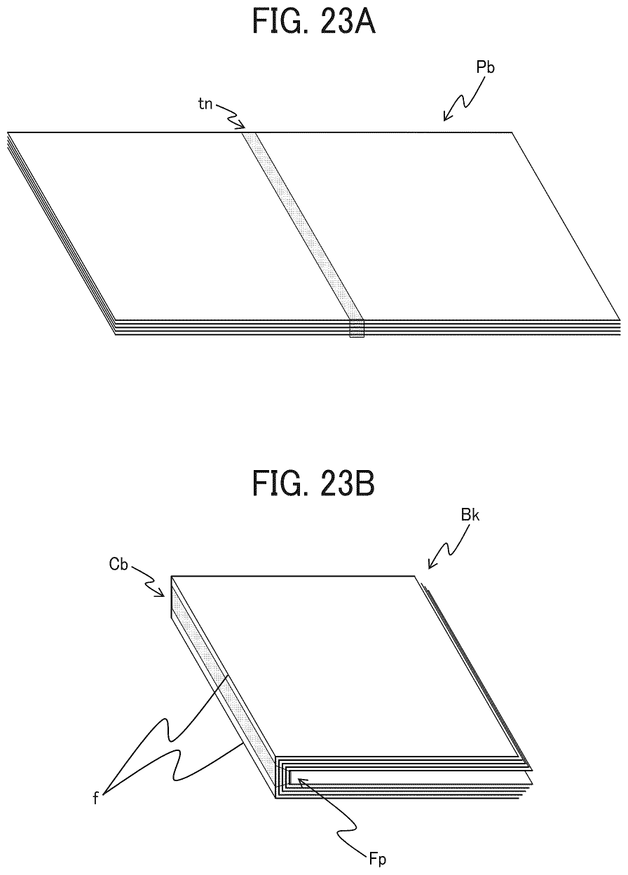

FIG. 23A is a schematic view of the sheet bundle Pb that has yet to be subjected to the crimp center binding (including the center folding and the crimp binding) in the eighth modification. FIG. 23A corresponds to the state of FIG. 6A. As illustrated in FIG. 23A, a toner image “tn” is formed at a position corresponding to a fold portion of the booklet Bk by the image forming apparatus 101 using toner for forming a visible image, for adhesion. The toner image corresponds to an adhesive medium formed on an adhesive portion of the sheet bundle Pb.

Note that a detailed method for forming the toner image “tn” for adhesion by the image forming apparatus 101 is a known technique as disclosed in, for example, Japanese Unexamined Patent Application Publication No. 2004-209858.

FIG. 23B is a schematic view of the booklet bk formed by center folding and crimp binding in the eighth modification.

As illustrated in FIG. 23B, the back portion Cb of the booklet Bk has a square back. Then, the toner image “tn” for adhesion is reheated on the back portion Cb. As a result, the toner image “tn” on an overlapping portion of a plurality of sheets P forming a flat portion (back portion Cb) of a square back exerts adhesive force to perform toner crimp binding.

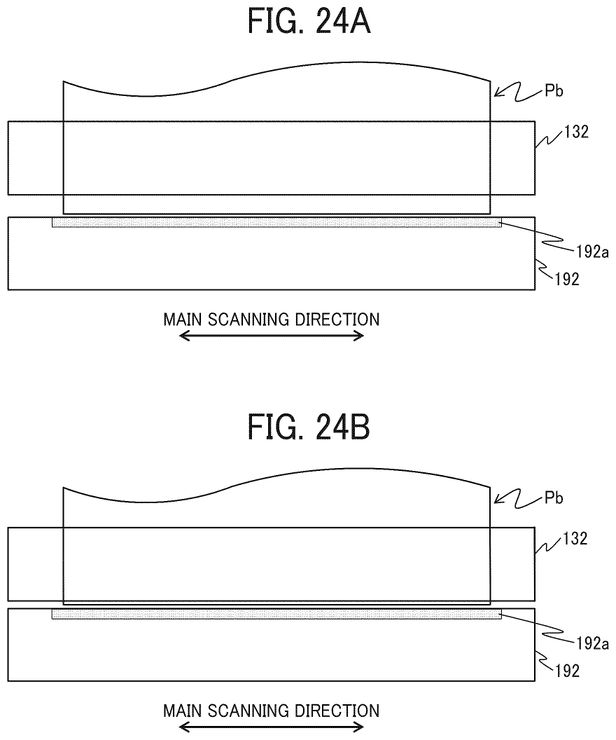

Next, a ninth modification of the crimp center binder will be described with reference to FIGS. 24A and 24B.

A crimp center binder according to the ninth modification differs from the crimp center binder according to the eighth modification in that the folding-blade engagement member includes a folding-blade engagement die 192 as a blade member extending in the width direction, instead of the folding-blade engagement roller 134 as a roller member that moves while rotating in the main scanning direction. Note that constituent elements common to the crimp center binders according to the present modification and the first embodiment are denoted by the same reference numerals, and detailed description thereof will be omitted.

FIGS. 24A and 24B are cross-sectional views of the crimp center binder according to the ninth modification, which illustrate operation of the crimp center binder.

FIGS. 24A and 24B are cross-sectional views of the crimp center binder taken along line B-B as viewed from the sheet conveyance direction side at the center line of center folding, that is, at the center position of the thickness of the folding blade 132.

FIG. 24A corresponds to the state of FIG. 6C. The folding blade 132 has pushed the sheet bundle Pb to a position beyond the nip position of the folding roller pair 133. The folding-blade engagement die 192 is located at the standby position (HP position), and is separated from the sheet bundle Pb in the center-folding ejection direction.

The folding-blade engagement die 192 is moved toward the folding blade by the folding-blade-engagement-die movement motor 182 (see FIG. 10).

FIG. 24B corresponds to the state of FIG. 6D. The folding-blade engagement die 192 is pressed against the folding blade 132 with the sheet bundle Pb interposed therebetween, and a heat-crimping portion 192a of the folding-blade engagement roller is pressed against the pushing surface of the folding blade 132 to heat and pressurize the sheet bundle Pb interposed therebetween. As a result, the back portion of the sheet bundle Pb is crimped and bound.

### Second Embodiment

Next, a second embodiment of the image forming system according to the present disclosure will be described.

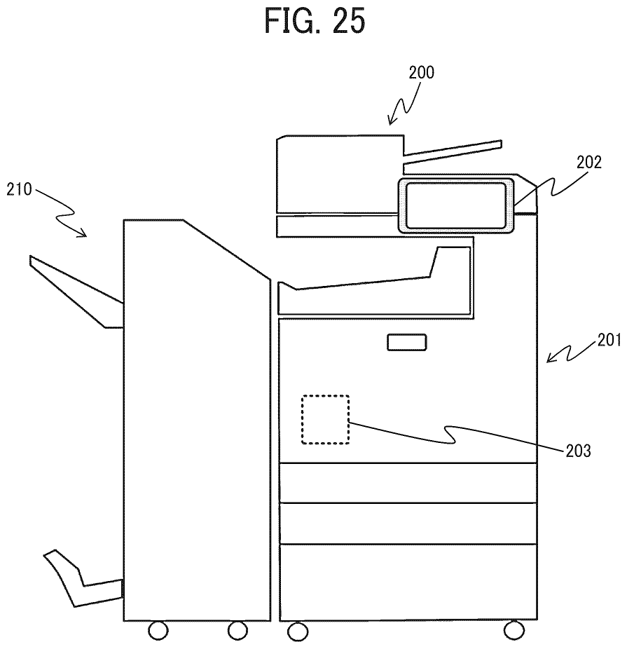

FIG. 25 is a diagram illustrating an overall configuration of an image forming system 200 such as a multifunction printer (MFP), as the second embodiment of the image forming system.

The image forming system 200 has a function of forming an image on a sheet P (medium) and performing post-processing on the sheet P on which the image has been formed. As illustrated in FIG. 25, the image forming system 200 includes an image forming apparatus 201 and a post-processing apparatus 210. The post-processing apparatus 210 is a console-type apparatus disposed adjacent to the image forming apparatus.

The image forming apparatus 201 forms an image on the sheet P, and ejects the sheet P on which the image has been formed to the post-processing apparatus 210. The image forming apparatus 201 includes a tray, a conveyor, and an image former. Sheets P are stored in the tray. The conveyor conveys a sheet P stored in the tray. The image former forms an image on the sheet P conveyed by the conveyor. The image former may be an inkjet image forming device that forms an image with ink or an electrophotographic image forming device that forms an image with toner. The image forming apparatus 201 includes an operation panel 202, and a controller 203 that controls the operations of the image forming apparatus 201.

The operation panel 202 has the same configuration as the configuration of the operation panel 102, thus the detailed description of the operation panel 202 will be omitted. Similarly, the controller 203 has the same configuration as the configuration of the controller 103, thus the detailed description of the controller 203 will be omitted. Since any configuration other than the above-described configuration of the image forming apparatus 201 is already known, detailed description of the image forming apparatus 201 will be omitted.

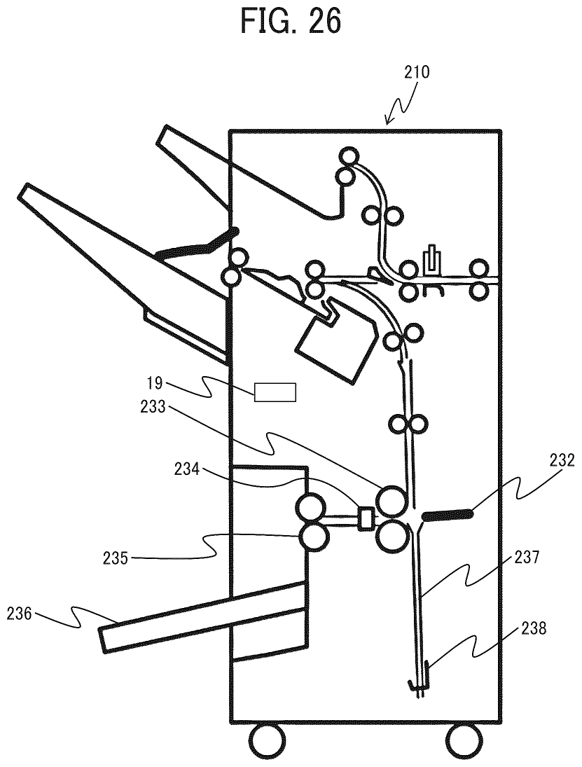

FIG. 26 is a diagram illustrating an internal structure of the post-processing apparatus 210 according to the second embodiment.

The post-processing apparatus 210 performs post-processing on the sheet P on which an image has been formed by the image forming apparatus 201. The post-processing according to the present embodiment is binding as a process to bind the sheets P on each of which an image is formed as a bundle of sheets P. In the following description, the bundle of sheets P may be referred to as a “sheet bundle Pb.” More specifically, the binding according to the present embodiment includes so-called “crimp binding” and “stapling.” The crimp binding is a process to press and deform the sheet bundle Pb at a crimp binding position. The stapling is a process to bind the sheet bundle Pb with a staple. The crimp binding includes edge binding and center binding. The edge binding is a process to bind an edge of the sheet bundle Pb. The center binding is a process to bind the center portion of the sheet bundle Pb.

Constituent elements common to the crimp center binders according to the present embodiment and the first embodiment are denoted by the same reference numerals, and detailed description thereof will be omitted.

### Crimp Center Binding

As illustrated in FIG. 26, the post-processing apparatus 210 includes a folding blade 232, a folding roller pair 233, a folding-blade engagement roller 234, a center-folded booklet ejection roller pair 235, and a center-folded booklet ejection tray 236.

The conveyance rollers place sheets P on a center-binding inner tray 237, and switchback-convey the sheets P on the center-binding inner tray 237 toward a movable end fence 238.

A plurality of sheets P conveyed in sequence is temporarily placed on the center-binding inner tray 237. The movable end fence 238 is movable in a conveyance direction of the sheets P along the center-binding inner tray 237. The movable end fence 238 aligns the sheets P such that the folding blade 232 faces a central position of a sheet conveyance direction length according to a sheet size. The side fence aligns the sheets P or the sheet bundle Pb placed on the center-binding inner tray 237 in a main scanning direction (width direction). A crimp center binder performs center binding on the sheet bundle Pb aligned by the movable end fence 238 and the side fence. The sheet bundle Pb subjected to center binding is ejected by the center-folded booklet ejection roller pair 235, and is placed on the center-folded booklet ejection tray 236.

Embodiments of the present disclosure are not limited to the above-described embodiments and modifications, and numerous additional modifications and variations are possible in light of the teachings. The technical contents included in the technical ideas described in the appended claims are included within the technical scope of the appended claims. The above-described embodiments and modifications are some examples, and various modifications and variations can be practiced from such examples by those skilled in the art. Such modifications and variations are included in the technical scope described in the appended claims.

Aspects of the present disclosure are, for example, as follows.

### First Aspect

In a first aspect, a sheet processing apparatus includes a center folder, and a back portion crimp binder including a back portion formation processing unit and a crimp-binding processing unit. The center folder perform a center folding on a sheet bundle including multiple sheets. The back portion crimp binder form a back portion on the sheet bundle subjected to the center folding, and perform a crimp-binding process on the back portion of the sheet bundle subjected to the center folding. The back portion formation processing unit performs the back-forming process to form the back portion on the sheet bundle subjected to the center folding. The crimp-binding processing unit performs the crimp-binding process on the sheet bundle subjected to the center folding.

### Second Aspect

In a second aspect, the sheet processing apparatus according to the first aspect, the center folder includes a folding plate to guide the sheet bundle in a given direction, and a folding roller pair to nip the sheet bundle guided by the folding plate and further convey the sheet bundle in the given direction.

### Third Aspect

In a third aspect, the sheet processing apparatus according to the first aspect, the back-formation processing unit includes the folding plate, and a folding-plate engagement member to engage with the folding plate via the sheet bundle.

### Fourth Aspect

In a fourth aspect, the sheet processing apparatus according to the third aspect, the folding-plate engagement member is biased toward the folding plate, and presses the back portion of the sheet bundle by nipping the back portion of the sheet bundle with the folding plate.

### Fifth Aspect

In a fifth aspect, the sheet processing apparatus according to the fourth aspect, the folding-plate engagement member includes a roller rotatable around a rotation axis, and reciprocally moves in a longitudinal direction of the back portion, and perform the back-forming process by which the back portion is formed on the sheet bundle and the crimp-binding process.

### Sixth Aspect

In a sixth aspect, the sheet processing apparatus according to any one of the third to fifth aspects, the folding plate includes a folding-crimping teeth portion having a protruding-recessed shape on a face facing the folding-plate engagement member, and the folding-plate engagement member includes an engaging-crimping teeth portion having a protruding-recessed shape to engage with the folding-crimping teeth portion.

### Seventh Aspect

In a seventh aspect, the sheet processing apparatus according to any one of the third to sixth aspects, the folding-plate engagement member moves in a longitudinal direction of the back portion of the sheet bundle to simultaneously perform the back-forming process by which the back portion is formed on the sheet bundle and the crimp-binding process.

### Eighth Aspect

In an eighth aspect, the sheet processing apparatus according to the sixth aspect or the seventh aspect, the folding plate includes a folding-plate crimping tooth group having a protruding-recessed shape and disposed on an opposite face opposite to the folding-plate engagement member. The folding-plate engagement member includes an engaging-crimping tooth group having an intermittently protruding-recessed portion to engage with the at least one folding-plate crimping tooth group. The folding plate is moved toward the folding-plate engagement member to perform the crimp-binding process.

### Ninth Aspect

In a ninth aspect, the sheet processing apparatus according to the third aspect, the folding-plate engagement member includes a planar blade disposed opposite to the folding plate, and the planar blade is moved toward the folding-plate engagement member to perform the crimp-binding process.

### Tenth Aspect

In a tenth aspect, the sheet processing apparatus according to any one of the first to ninth aspects, the back-portion crimp binder includes a first roller having teeth, and a second roller to engage with the first roller via the sheet bundle.

### Eleventh Aspect

In an eleventh aspect, the sheet processing apparatus according to the sixth aspect, the folding-plate engagement member includes a cylindrical portion having an engaging-crimping teeth, and flanges disposed at both ends of the cylindrical portion and each having a diameter larger than a diameter of the cylindrical portion.

### Twelfth aspect

In a twelfth aspect, the sheet processing apparatus according to the eleventh aspect, the flanges are engaged with each other across the opposite faces to the folding-plate engagement member.

### Thirteenth Aspect

In a thirteenth aspect, the sheet processing apparatus according to any one of the first to twelfth aspects, the back-portion crimp binder forms two fold lines parallel in a longitudinal direction with the back portion of the sheet bundle.

### Fourteenth Aspect

In a fourteenth aspect, the sheet processing apparatus according to the thirteenth aspect, the back portion of the sheet bundle is formed to be a substantially flat portion between the two fold lines.

### Fifteenth Aspect

In a fifteenth aspect, the sheet processing apparatus according to the sixth aspect, the engaging-crimping teeth portion has a continuous protruding-recessed portion in a main scanning direction of the sheet bundle.

### Sixteenth Aspect

In a sixteenth aspect, the sheet processing apparatus according to the sixth aspect, the engaging-crimping teeth portion has a continuous protruding-recessed portion inclined with respect to a main scanning direction of the sheet bundle.

### Seventeenth Aspect

In a seventeenth aspect, the sheet processing apparatus according to the sixth aspect, the folding plate has wherein the folding plate has a folding-crimping teeth portion having a protruding-recessed shape at multiple positions in a portion on a face facing the folding-plate engagement member, and has a flat portion in another portion other than the portion, on the face facing the folding-plate engagement member.

### Eighteenth Aspect

In an eighteenth aspect, an image forming system includes an image forming apparatus, and the sheet processing apparatus according to any one of the first to seventeenth aspects, disposed in an in-body space of the image forming apparatus.

### Nineteenth Aspect

In a nineteenth aspect, an image forming system includes an image forming apparatus, and the sheet processing apparatus according to any one of the first to seventeenth aspects, to perform a given process on the sheet on which the image is formed by the image forming apparatus.

### Twentieth Aspect

In a twentieth aspect, a sheet processing method is executable in a sheet processing apparatus including a center folder to perform a center folding on a sheet bundle including multiple sheets, a back-portion formation processing unit to form a back portion on a sheet bundle subjected to the center folding and perform a crimp-binding process on the back portion of the sheet bundle subjected to the center folding. The sheet processing method performs the back-portion formation processing unit to form a back portion on a fold formed on the sheet bundle, and performs the crimp-binding process on the sheet bundle subjected to the center folding.

### Twenty-First Aspect

In a twenty-first aspect, the sheet processing apparatus according to the second aspect, the back-crimp binder includes the folding plate, and a folding-plate engagement heater including a heater to press the sheet bundle toward the folding plate and heat the sheet bundle. The folding-plate engagement heater is to heat an adhesive medium formed on an adhesive portion of the sheet bundle.

### Twenty-Second Aspect

In a twenty-second aspect, the sheet processing apparatus according to the twenty-first aspect, the adhesive medium includes a toner with which a visible image is formed.

### Twenty-Third Aspect

In a twenty-third aspect, the sheet processing apparatus according to the twenty-first aspect, the folding-plate engagement heater includes a roller rotatable around a rotation axis, and the folding-plate engagement member reciprocally moves in a longitudinal direction of the back portion to perform the back-forming process and the crimp-binding process.

### Twenty-Fourth Aspect

In a twenty-fourth aspect, the sheet processing apparatus according to the twenty-first aspect, the folding-plate engagement member includes a planar blade disposed opposite to the folding plate, and the planar blade moves toward the folding-plate engagement member to perform the crimp-binding process.

### Twenty-Fifth Aspect

In a twenty-fifth aspect, an image forming system includes an image forming apparatus, and the sheet processing apparatus to perform a given process on the sheet on which the image is formed by the image forming apparatus. The sheet processing apparatus is a sheet processing apparatus according to any one of the twenty-first to twenty-fourth aspects.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Applications No. 2023-117060, filed on Jul. 18, 2023, and No. 2024-062264, filed on Apr. 8, 2024, in the Japan Patent Office, the entire disclosures of which are hereby incorporated by reference herein.

### REFERENCE SIGNS LIST

19: controller
100: image forming system
101: image forming apparatus
102: operation panel
110: post-processing apparatus
117: staple-edge-binding processing unit
120: ejection tray
131: movable end fence
132: folding blade
132a: folding-crimping teeth portion
132b: crimp-roller rail
133: folding roller pair
134: folding-blade engagement roller
134a: engaging-crimping teeth portion
134b: flange portion
135: center-folded booklet ejection roller pair
136: center-folded booklet ejection tray
141: folding-blade movement motor
142: folding-roller-pair rotation motor
143: folding-roller-pair movement motor
144: folding-roller-pair pressurizing member
145: folding-blade-engagement-roller scanning motor
146: engagement-roller guide rail
147: folding-blade-engagement-roller pressurizing member
177: upper crimping teeth
178: lower crimping teeth
181: folding-blade engagement die
181a: die-crimping portion
181b: flange portion
182: folding-blade-engagement-die movement motor
183: folding-blade-engagement-die pressurizing member
184: folding blade
184a: teeth
185: folding-blade engagement die
185a: crimping portion
186: folding-blade engagement die
186a: crimping portion
187: crimp roller
187a: teeth
188: crimp-roller movement motor
191: folding-blade engagement roller
191a: heat-crimping portion
191b: flange portion
192: folding-blade engagement die

1. A sheet processing apparatus comprising:
a center folder configured to perform a center folding on a sheet bundle including multiple sheets; and
a back-crimp binder including
a back-portion former configured to form a back portion on the sheet bundle subjected to the center folding; and
a crimp binder configured to perform a crimp binding on the sheet bundle subjected to the center folding,
wherein the center folder includes
a folding plate configured to guide a part of the sheet bundle in a given direction; and
a folding roller pair configured to
nip the sheet bundle guided by the folding plate; and
advance the sheet bundle in the given direction, and
wherein the back-crimp binder includes
the folding plate; and
a folding-plate engagement member configured to engage with the folding plate via the sheet bundle.

2. (canceled)

3. (canceled)

4. The sheet processing apparatus according to claim 1, wherein
the folding-plate engagement member is biased toward the folding plate, and
the folding-plate engagement member is configured to nips the back portion of the sheet bundle between the folding-plate engagement member and the folding plate and press the back portion of the sheet bundle.

5. The sheet processing apparatus according to claim 4, further comprising a controller configured to control the center folder and the back-crimp binder,
wherein the folding-plate engagement member includes a roller rotatable about an axis, and
the controller is further configured to cause the folding-plate engagement member to
reciprocally move in a longitudinal direction of the back portion; and
perform a back-portion-forming process to form the back portion on the sheet bundle and a crimp-binding process.

6. The sheet processing apparatus according to claim 1, wherein
the folding plate has first teeth having multiple protrusions and recesses on a face facing the folding-plate engagement member, and
the folding-plate engagement member has second teeth having multiple protrusions and recesses configured to engage with the first teeth.

7. The sheet processing apparatus according to claim 1, wherein the folding-plate engagement member is configured to moves in a longitudinal direction of the back portion of the sheet bundle to simultaneously perform a back-portion-forming process to form the back portion on the sheet bundle and perform a crimp-binding process.

8. The sheet processing apparatus according to claim 6, wherein
the folding plate has at least one first teeth group having multiple protrusions and recesses on a face facing the folding-plate engagement member,
the folding-plate engagement member includes at least one second teeth group having intermittently multiple intermittent protrusions and recesses the at least one second teeth group configured to engage with the at least one first teeth group, and
the folding plate is configured to moves toward the folding-plate engagement member to perform the crimp binding.

9. The sheet processing apparatus according to claim 1, wherein
the folding-plate engagement member includes a planar blade facing the folding plate, and
the planar blade is configured to moves toward the folding plate to perform the crimp binding.

10. The sheet processing apparatus according to claim 1,
wherein the back-crimp binder includes:
a first roller having teeth; and
a second roller configured to engage with the first roller via the sheet bundle.

11. The sheet processing apparatus according to claim 6,
wherein the folding-plate engagement member includes:
a cylindrical portion having the second teeth; and
flange portions at both ends of the cylindrical portion and each having a diameter larger than a diameter of the cylindrical portion.

12. (canceled)

13. (canceled)

14. (canceled)

15. The sheet processing apparatus according to claim 6,
wherein the second teeth have multiple continuous protrusions and recesses repeatedly formed with respect to a longitudinal direction of a back portion of the sheet bundle.

16. The sheet processing apparatus according to claim 6,
wherein the second teeth have multiple continuous protrusions and recesses repeatedly formed and inclined with respect to a longitudinal direction of a back portion of the sheet bundle.

17. The sheet processing apparatus according to claim 6, wherein
the folding plate has a folding-crimping teeth portion having multiple protrusions and recesses at multiple positions in a first portion on a face facing the folding-plate engagement member, and
the folding plate has a flat portion in a second portion different from the first portion, on the face facing the folding-plate engagement member.

18. An image forming system comprising:
an image forming apparatus to form an image on a sheet; and
the sheet processing apparatus according to claim 1, the sheet processing apparatus in an in-body ejection space of the image forming apparatus.

19. An image forming system comprising:
an image forming apparatus to form an image on a sheet; and
the sheet processing apparatus according to claim 1, the sheet processing apparatus configured to perform a given process on the sheet on which the image has been formed by the image forming apparatus.

20. A sheet processing method comprising:
performing a center folding using a center folder, on a sheet bundle including multiple sheets;
forming a back portion using a back-crimp binder on the sheet bundle subjected to the center folding; and
performing a crimp binding using the back-crimp binder on the sheet bundle subjected to the center folding,
wherein the center folder includes
folding plate configured to guide a part of the sheet bundle e in a given direction; and
a folding roller pair configured to
nip the sheet bundle guided by the folding plate, and
advance the sheet bundle in the given direction, and
wherein the back-crimp binder includes
the folding plate; and
a folding-plate engagement member configured to engage with the folding plate via the sheet bundle.

21. The sheet processing apparatus according to claim 1, wherein
the folding-plate engagement member is a folding-plate-engagement heater including a heater configured to heat the sheet bundle and press the sheet bundle against the folding plate, and
the folding-plate-engagement heater is configured to heats an adhesive medium in an adhesive portion of the sheet bundle.

22. The sheet processing apparatus according to claim 21,
wherein the adhesive medium includes a toner image as a visible image.

23. The sheet processing apparatus according to claim 21, wherein
the folding-plate-engagement heater includes a roller configured to be rotatable around an axis, and
the folding-plate-engagement heater is configured to reciprocally moves in a longitudinal direction of the back portion of the sheet bundle to perform a back-portion-forming process to form the back portion on the sheet bundle and the crimp binding.

24. The sheet processing apparatus according to claim 21, wherein
the folding-plate-engagement heater includes a planar blade facing the folding plate, and
the planar blade is configured to moves toward the folding plate to perform the crimp binding.

25. An image forming system comprising:
an image forming apparatus to form an image on a sheet; and
the sheet processing apparatus according to claim 1, the sheet processing apparatus configured to perform a given process on the sheet on which the image has been formed by the image forming apparatus.
